(19) United States
(12) Patent Application Publication
(10) Pub. No.: US 2022/0340128 A1
(43) Pub. Date: Oct. 27, 2022

(54) AUTOMATIC VALET PARKING SYSTEM

(71) Applicant: DENSO CORPORATION, Kariya-city (JP)

(72) Inventors: Masayoshi ASANO, Kariya-city (JP); Syota MIZOGUCHI, Kariya-city (JP)

(21) Appl. No.: 17/863,819

(22) Filed: Jul. 13, 2022

Related U.S. Application Data
(63) Continuation of application No. PCT/JP2021/000091, filed on Jan. 5, 2021.

(30) Foreign Application Priority Data
Jan. 15, 2020 (JP) 2020-004401

(51) Int. Cl. B60W 30/06; G08G 1/14; G06F 16/29

(52) U.S. Cl. CPC B60W 30/06; G08G 1/14; G06F 16/29; B60W 2556/65; B60W 2556/40

(57) ABSTRACT

An automatic valet parking system includes a vehicle, a parking server, and a map server including a database. The vehicle includes: an operation plan determination portion that determines whether the saver-side operation plan is false; a request generating portion that requests the map server to transmit the parkable region information when the server-side operation plan is false; a vehicle-side operation planning portion that generates, based on the parkable region information, a vehicle-side operation plan including a route for guiding the vehicle to the target position in the unmanageable region in response to receiving the parkable region information; and an automatic operation control portion that is configured to: perform the automatic operation control according to the server-side operation plan when the server-side operation plan is not false; and perform the automatic operation control according to the vehicle-side operation plan when the server-side operation plan is false.

### CROSS REFERENCE TO RELATED APPLICATIONS

This application is a continuation application of International Patent Application No. PCT/JP2021/000091 filed on Jan. 5, 2021, which designated the U.S. and claims the benefit of priority from Japanese Patent Application No. 2020-004401 filed on Jan. 15, 2020. The entire disclosure of all of the above application is incorporated herein by reference.

### TECHNICAL FIELD

The present disclosure relates to an automatic valet parking system that provides valet parking under automatic operation control.

### BACKGROUND ART

Conventionally, there has been proposed the technology concerning a valet parking systes under automatic operation control. In the present specification, the valet parking system under automatic operation control may be referred to as an automatic valet parking system. According to the conventional technology, an operation plan is generated by a server such as a management server disposed in a parking place and is transmitted to vehicles.

### SUMMARY

One aspect of the present disclosure is an automatic valet parking system for providing valet parking under automatic operation control. The system includes: a vehicle configured to transmit/receive data to/from other vehicles; a parking server; and a map server including a database that stores information relating to regions in a parking place. The parking place is divided into at least a manageable region that is managed by the parking server and an unmanageable region that is not managed by the parking server. The parking server includes a server-side operation planning portion that is configured to generate a server-side operation plan including a route for guiding the vehicle to a target position in the manageable region and to transmit the server-side operation plan to the vehicle. The map server includes an information acquisition portion that is configured to acquire, from the database, parkable region information in response to receiving a request from the vehicle and to transmit the parkable region information to the vehicle, wherein the parkable region information indicates a region in the unmanageable region where the vehicle is able to be parked. The vehicle includes: an operation plan determination portion that is configured to determine whether the saver-side operation plan is false; a request generating portion that is configured to request the map server to transmit the parkable region information when the operation plan determination portion determines that the server-side operation plan is false; a vehicle-side operation planning portion that is configured to generate, based on the parkable region information, a vehicle-side operation plan including a route for guiding the vehicle to the target position in the unmanageable region in response to receiving the parkable region information; and an automatic operation control portion that is configured to: perform the automatic operation control according to the server-side operation plan when the operation plan determination portion determines that the server-side operation plan is not false; and perform the automatic operation control according to the vehicle-side operation plan when the operation plan determination portion determines that the server-side operation plan is false.

### BRIEF DESCRIPTION OF DRAWINGS

The above and other objects, features and advantages of the present disclosure will become more apparent from the following detailed description made with reference to the accompanying drawings.

The above and other objects, features, and advantages of the present disclosure will become more apparent from the following detailed description made by reference to the accompanying drawings. In the drawings:

FIG. 1 is a diagram illustrating an overall configuration of the automatic valet parking system according to a first embodiment;

FIG. 2 is a diagram schematically illustrating a detailed configuration of components of the automatic valet parking system according to the first embodiment;

FIG. 3 is a diagram illustrating a process flow of each part during implementation of the automatic valet parking according to the first embodiment (part 1 of 2);

FIG. 4 is a diagram illustrating the contents of an expansion request process according to the first embodiment;

FIG. 5 is a diagram illustrating a process flow of each part during implementation of the automatic valet parking according to the first embodiment (part 2 of 2);

FIG. 6 is a diagram illustrating the contents of a first process of a changeover process according to the first embodiment;

FIG. 7 is a diagram illustrating the contents of a second process of the changeover process according to the first embodiment;

FIG. 8 is a diagram illustrating the contents of a parking process according to the first embodiment;

FIG. 9 is a diagram illustrating the contents of a starting process according to the first embodiment;

FIG. 10 is a diagram illustrating case 1 of the operation plan determination according to the first embodiment;

FIG. 11 is a diagram illustrating case 2 of the operation plan determination according to the first embodiment;

FIG. 12 is a diagram illustrating case 3 of the operation plan determination according to the first embodiment;

FIG. 13 is a diagram schematically illustrating an overall configuration of the automatic valet parking system according to a second embodiment;

FIG. 14 is a diagram schematically illustrating a detailed configuration of components of the automatic valet parking system according to the second embodiment;

FIG. 15 is a diagram illustrating a process flow of each part during implementation of the automatic valet parking according to the second embodiment (part 1 of 2);

FIG. 16 is a diagram illustrating a process flow of each part during implementation of the automatic valet parking according to the second embodiment (part 2 of 2);

FIG. 17 is a diagram illustrating the contents of the expansion request process according to the second embodiment;

FIG. 18 is a diagram illustrating the contents of a second process of the changeover process according to the second embodiment;

FIG. 19 is a diagram schematically illustrating a detailed configuration of components of the automatic valet parking system according to a third embodiment;

FIG. 20 is a diagram illustrating the contents of a first process of the changeover process according to the third embodiment;

FIG. 21 is a diagram illustrating the contents of the parking process according to the third embodiment; and

FIG. 22 is a diagram illustrating the contents of the starting process according to the third embodiment.

### DESCRIPTION OF EMBODIMENTS

To begin with, a relevant technology will be described only for understanding the following embodiments.

There may be a case where a malicious third party such as a hacker intercepts the communication between the parking server and the vehicle. In such a case, the above-described conventional system may transmit a falsified operation plan to the vehicle. The vehicle provides automatic operation control based on the falsified operation plan. The vehicle may not be able to park at the correct parking position or may be stolen in the worst case. The above-described conventional system does not sufficiently enhance the system security and leaves the security issue unresolved.

It is one objective of the present disclosure to provide an automatic valet parking system capable of enhancing system security.

As described above, the one aspect of the present disclosure is an automatic valet parking system for providing valet parking under automatic operation control. The system includes: a vehicle configured to transmit/receive data to/from other vehicles; a parking server; and a map server including a database that stores information relating to regions in a parking place. The parking place is divided into at least a manageable region that is managed by the parking server and an unmanageable region that is not managed by the parking server. The parking server includes a server-side operation planning portion that is configured to generate a server-side operation plan including a route for guiding the vehicle to a target position in the manageable region and to transmit the server-side operation plan to the vehicle. The map server includes an information acquisition portion that is configured to acquire, from the database, parkable region information in response to receiving a request from the vehicle and to transmit the parkable region information to the vehicle, wherein the parkable region information indicates a region in the unmanageable region where the vehicle is able to be parked. The vehicle includes: an operation plan determination portion that is configured to determine whether the saver-side operation plan is false; a request generating portion that is configured to request the map server to transmit the parkable region information when the operation plan determination portion determines that the server-side operation plan is false; a vehicle-side operation planning portion that is configured to generate, based on the parkable region information, a vehicle-side operation plan including a route for guiding the vehicle to the target position in the unmanageable region in response to receiving the parkable region information; and an automatic operation control portion that is configured to: perform the automatic operation control according to the server-side operation plan when the operation plan determination portion determines that the server-side operation plan is not false; and perform the automatic operation control according to the vehicle-side operation plan when the operation plan determination portion determines that the server-side operation plan is false.

A second aspect of the present disclosure is an automatic valet parking system for providing valet parking under automatic operation control. The system includes: a vehicle configured to transmit/receive data to/from other vehicles; a parking server; and a map server including a database that stores information relating to regions in a parking place. The parking place is divided into at least a manageable region that is managed by the parking server and an unmanageable region that is not managed by the parking server. The parking server includes at least one parking server processor programmed to generate a server-side operation plan including a route for guiding the vehicle to a target position in the manageable region and to transmit the server-side operation plan to the vehicle. The map server includes at least one map server processor programmed to acquire, from the database, parkable region information in response to receiving a request from the vehicle and to transmit the parkable region information to the vehicle, wherein the parkable region information indicates a region in the unmanageable region where the vehicle is able to be parked. The vehicle includes at least one vehicle processor programmed to: determine whether the saver-side operation plan is false; request the map server to transmit the parkable region information upon determining that the server-side operation plan is false; generate, based on the parkable region information, a vehicle-side operation plan including a route for guiding the vehicle to the target position in the unmanageable region in response to receiving the parkable region information; perform the automatic operation control according to the server-side operation plan upon determining that the server-side operation plan is not false; and perform the automatic operation control according to the vehicle-side operation plan upon determining that the server-side operation plan is false.

There may be a case where a malicious third party intercepts the communication between the parking place server apparatus and the vehicle and falsifies the server-side operation plan. In such a case, the above-described configuration provides vehicle-based automatic operation control to implement automatic parking at a target position in an unmanageable region that is not controlled by the parking place server apparatus, making it possible to park the vehicle safely.

The above-described configuration provides an excellent effect of improving the system security.

Hereinafter, embodiments of the present disclosure will be described with reference to the drawings. In the following embodiments, the same or equivalent parts are denoted by the same reference numerals as each other, and explanations will be provided to the same reference numerals for simplifying descriptions.

### First Embodiment

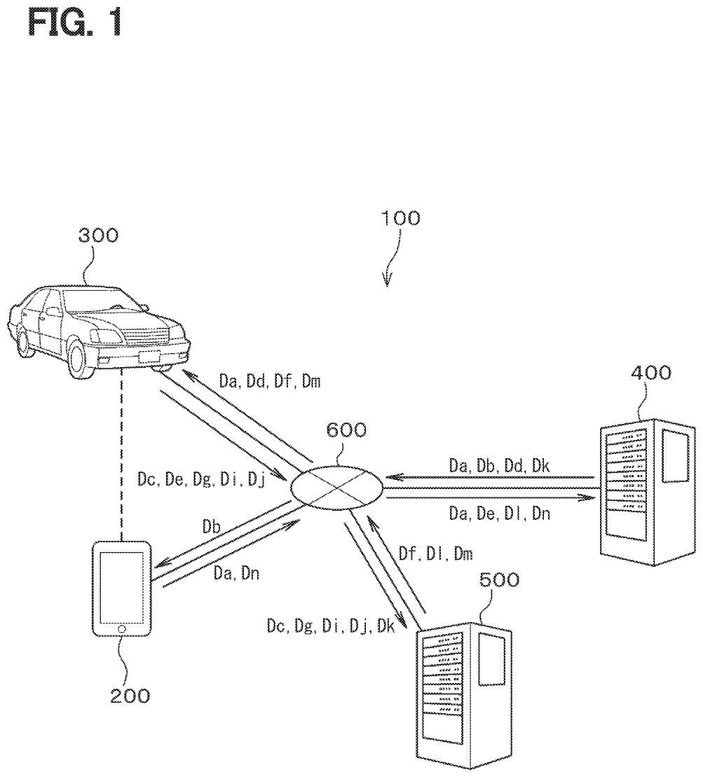

The first embodiment will be described by reference to FIGS. 1 through 12.

Overall Configuration of an Automatic Valet Parking System 100

As illustrated in FIG. 1, the automatic valet parking system 100 according to the present embodiment includes a terminal device 200, a vehicle 300 comparable to a vehicle, a parking server 400, and a map server 500. The automatic valet parking system 100 performs valet parking based on automatic operation control. In the present specification, the automatic valet parking may be acronym ized as AVP. The terminal device 200 includes a communication function and stores authentication information about the owner. The terminal device 200 and the vehicle 300 are configured to be capable of communication so that data can be mutually transmitted and received.

The terminal device 200 and the vehicle 300 may transmit and receive data via Near Field Communication as illustrated by a broken line in FIG. 1 or via a network 600. Examples of the network 600 include a wireless LAN and a mobile communication network. The terminal device 200 and the parking server 400 are communicably connected via the network 600. The vehicle 300 and the parking server 400 are communicably connected via the network 600. The AVP system 100 enables the terminal device 200, the vehicle 300, and the parking server 400 to mutually transmit and receive data.

According to the present embodiment, the terminal device 200 represents a smart device such as a smartphone or a tablet terminal. The terminal device 200 may represent an electronic key for vehicles that stores the owner's authentication information and includes a communication function. The vehicle 300 includes an automatic operation function. The vehicle 300 and the map server 500 are communicably connected via the network.

The parking server 400 is installed in the parking place of a facility that provides the valet parking service. The parking server 400 is managed and controlled by the facility or a parking management company contracted with the facility. The parking server 400 may be installed in a place different from the parking place such as the head office building of a parking place management company. The map server 500 acquires valid zone information and transmits it to the vehicle 300. The valid zone information concerns a valid zone for a temporary key described later.

The map server 500 comes under the jurisdiction and administration of a reliable third-party organization such as a public administration concerning the automatic operation control, a specialized official organization in charge of surveying, or pertinent organizations of the Ministry of Land, Infrastructure, Transport and Tourism. In this case, a region in the parking place is divided into at least a manageable region and an unmanageable region. The manageable region is managed by the parking server 400. The unmanageable region is not managed by the parking server 400. The map server 500 includes a database that stores information about the regions in the parking place.

Detailed Configuration of the Terminal Device 200

The terminal device 200 internally stores an electronic key. The authentication using the electronic key enables the vehicle 300 to perform the automatic operation. However, it is unfavorable to transmit the electronic key to external devices without any limitations because the security may degrade.

To solve this issue, the terminal device 200 generates a temporary key Da only when the AVP is performed. The temporary key Da functions similarly to the electronic key. The temporary key Da can authenticate the owner in the same way as the electronic key and enables the vehicle 300 to perform the automatic operation. However, the temporary key Da expires under conditions different from the electronic key when a predetermined validity period expires or the vehicle 300 exits from the valid zone, for example.

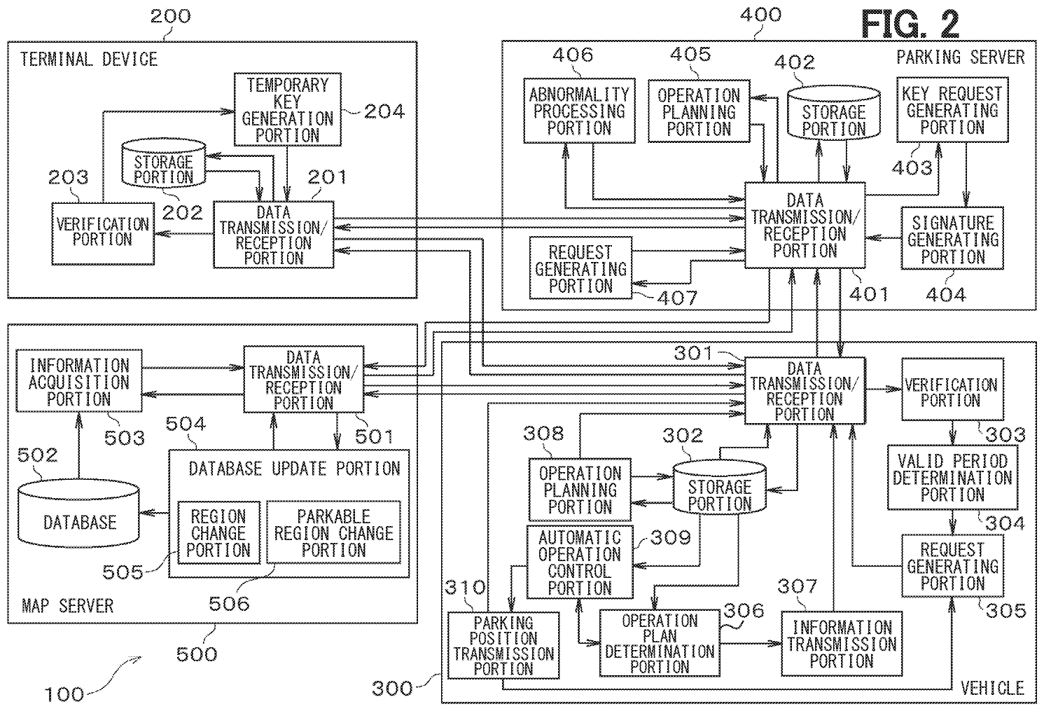

As illustrated in FIG. 2, the terminal device 200 includes a data transmission/reception portion 201 and a storage portion 202. The data transmission/reception portion 201 transmits and receives various data from external devices. The storage portion 202 stores various data. The storage portion 202 stores various predetermined information and various information received via the data transmission/reception portion 201. The terminal device 200 also includes functional blocks such as a verification portion 203 and a temporary key generation portion 204.

The functional blocks are provided as the software. Namely, the CPU included in the terminal device 200 executes a computer program stored in a non-transitory tangible storage medium and performs processes corresponding to the computer program. At least some of the functional blocks may be provided as the hardware.

The verification portion 203 receives a temporary key request Db transmitted from the parking server 400 via the data transmission/reception portion 201 and then verifies the authenticity of the temporary key request Db. The transmission of the temporary key request Db by the parking server 400 will be described later. The temporary key generation portion 204 generates a temporary key Da if the verification result from the verification portion 203 is true. The temporary key generation portion 204 transmits the generated temporary key Da to the vehicle 300 and the parking server 400 via the data transmission/reception portion 201.

Detailed Configuration of the Vehicle 300

The vehicle 300 includes a data transmission/reception portion 301 and a storage portion 302. The data transmission/reception portion 301 transmits and receives various data from external devices. The storage portion 302 stores various data. The storage portion 302 stores various predetermined information and various information received via the data transmission/reception portion 301. The vehicle 300 also includes functional blocks such as a verification portion 303, a valid period determination portion 304, a request generating portion 305, an operation plan determination portion 306, an information transmission portion 307, an operation planning portion 308, an automatic operation control portion 309, and a parking position transmission portion 310.

The functional blocks are provided as the software. Namely, the CPU included in the vehicle 300 executes a computer program stored in a non-transitory tangible storage medium and performs processes corresponding to the computer program. At least some of the functional blocks may be provided as the hardware.

The verification portion 303 receives the temporary keys Da transmitted from the terminal device 200 and the parking server 400 and then verifies the authenticity of the temporary keys Da. The transmission of the temporary key Da by the parking server 400 will be described later. Various methods can be used to verify the temporary key Da. An example method assigns a signature to the temporary key Da and verifies the signature.

The valid period determination portion 304 determines a valid period for the temporary key Da when the verification result from the verification portion 303 is true. The request generating portion 305 generates a zone information request Dc that requests the transmission of valid zone information. The zone information request Dc also contains information about the current position of the vehicle 300. The request generating portion 305 transmits the generated zone information request Dc to the map server 500 via the data transmission/reception portion 301. Each process performed by the request generating portion 305 is comparable to a request generation procedure.

The operation plan determination portion 306 receives the operation plan Dd transmitted from the parking server 400 and then determines the authenticity of the operation plan Dd. In this case, the “true” operation plan Dd is assumed to be unlikely to be falsified and correct. The “false” operation plan Dd is assumed to be likely to be falsified and incorrect. The transmission of the operation plan Dd by the parking server 400 will be described later. In the present specification, an operation plan generated by the parking server 400 may be referred to as a server-side operation plan. Each process performed by the operation plan determination portion 306 is comparable to an operation plan determination procedure.

The operation plan determination portion 306 may determine that the server-side operation plan Dd is incorrect and may be falsified. Then, the information transmission portion 307 acquires vehicle-related information De. The information transmission portion 307 transmits the acquired vehicle-related information De to the parking server 400 via the data transmission/reception portion 301. The vehicle-related information De concerns the vehicle 300 and may include information around the vehicle 300 such as video near a target parking position for the vehicle 300, information acquired from various sensors installed on the vehicle 300, and position information indicating the current position of the vehicle 300. These pieces of information can be acquired not only from cameras and various sensors mounted on the vehicle 300 but also from cameras and various sensors installed in the parking place. Each process performed by the information transmission portion 307 is comparable to an information transmission procedure.

The operation plan determination portion 306 may determine that the server-side operation plan Dd is incorrect and may be falsified. Then, the request generating portion 305 generates a region information request Dg requesting transmission of parkable region information Df. The request generating portion 305 transmits the generated region information request Dg to the map server 500 via the data transmission/reception portion 301. The parkable region information Df indicates a region capable of parking the vehicle 300 in the unmanageable region.

The operation planning portion 308 functions as a vehicle-side operation planning portion. The operation planning portion 308 receives the parkable region information Df transmitted from the map server 500 via the data transmission/reception portion 301 and then generates an operation plan Dh based on the parkable region information Df. Each process performed by the operation planning portion 308 is comparable to a vehicle-side operation plan procedure. The transmission of the parkable region information Df by the map server 500 will be described later. The operation plan Dh includes the current position of the vehicle 300, target positions included in the unmanageable region, a route to guide the vehicle 300 from the current position to the target position, the timing for the vehicle 300 to go straight, turn to the right or left, and reverse, and travel speeds, for example. In the present specification, the operation plan generated by the vehicle 300 may be referred to as a vehicle-side operation plan.

The operation plan determination portion 306 may determine that the server-side operation plan Dd is correct and unlikely to be falsified. Then, the automatic operation control portion 309 provides automatic operation control according to the server-side operation plan Dd. The operation plan determination portion 306 may determine that the server-side operation plan Dd is incorrect and may be falsified. Then, the automatic operation control portion 309 provides automatic operation control according to the vehicle-side operation plan Dh. Each operation performed by the automatic operation control portion 309 is comparable to an automatic operation control procedure.

Suppose the automatic operation control portion 307 provides automatic operation control according to the vehicle-side operation plan Dh to complete parking of the vehicle 300 at a target position included in the unmanageable region. Then, the parking position transmission portion 310 generates parking position information Di indicating the parked position, namely, the parking position of the vehicle 300. The parking position transmission portion 310 transmits the generated parking position information Di to the map server 500 via the data transmission/reception portion 301.

Suppose the vehicle 300 parked at the target position included in the unmanageable region starts to leave the parking place. Then, the parking position transmission portion 310 generates starting information Dj indicating that the vehicle 300 starts. The parking position transmission portion 310 transmits the generated starting information Dj and parking position information Di to the map server 500 via the data transmission/reception portion 301. Each process performed by the parking position transmission portion 310 is comparable to a parking position transmission procedure.

Detailed Configuration of the Parking Server 400

The parking server 400 includes a data transmission/reception portion 401 and a storage portion 402. The data transmission/reception portion 401 transmits and receives various data from external devices. The storage portion 402 stores various data. The storage portion 402 stores various predetermined information and various information received via the data transmission/reception portion 401. The parking server 400 also includes functional blocks such as a key request generating portion 403, a signature generating portion 404, an operation planning portion 405, an abnormal processing portion 406, and a request generating portion 407.

The functional blocks are provided as the software. Namely, the CPU included in the parking server 400 executes a computer program stored in a non-transitory tangible storage medium and performs processes corresponding to the computer program. At least some of the functional blocks may be provided as the hardware.

The key request generating portion 403 generates a temporary key request Db requesting the generation of the temporary key Da and transmits the temporary key request Db to the terminal device 200. The signature generating portion 404 supplies a signature to the temporary key request Db generated by the key request generating portion 403. The reason for supplying the signature is to enable the terminal device 200 to determine the authenticity of the temporary key request Db. The temporary key request Db supplied with the signature is transmitted to the terminal device 200 via the data transmission/reception portion 401.

The operation planning portion 405 functions as a server-side operation planning portion. The operation planning portion 405 receives the temporary key Da transmitted from the terminal device 200 via the data transmission/reception portion 401 and then generates a server-side operation plan Dd. The server-side operation plan Dd contains the current position of the vehicle 300, target positions included in the manageable region, a route to guide the vehicle 300 from the current position to a target position, the timing for the vehicle 300 to go straight, turn to the right or left, and reverse, and travel speeds, for example.

The operation planning portion 405 settles an optimal position as the above-described target position in consideration of parking slots existing in the manageable region, namely, the availability of the parking space. The operation planning portion 405 transmits the generated server-side operation plan Dd and temporary key Da to the vehicle 300 via the data transmission/reception portion 401. Each process performed by the operation planning portion 405 is comparable to a server-side operation plan procedure.

The abnormality processing portion 406 receives the vehicle-related information De transmitted from the vehicle 300 via the data transmission/reception portion 401 and then classifies an abnormality occurring around the vehicle 300 due to the server-side operation plan Dd based on the vehicle-related information De and the server-side operation plan Dd. Then, the abnormality processing portion 406 performs an abnormality management process corresponding to the result of the classification. Each process performed by the abnormality processing portion 406 is comparable to an abnormality correction procedure. The classification of abnormalities and the specific contents of the abnormality management process will be described later.

The request generating portion 407 may determine that the manageable region leaves no region for the vehicle 300 to park, and then generates a region expansion request Dk requesting the expansion of the manageable region. The request generating portion 407 transmits the generated region expansion request Dk to the map server 500 via the data transmission/reception portion 401. Namely, the request generating portion 407 may determine that the manageable region does not leave available parking slots and then requests the map server 500 to expand the manageable region. Each process performed by the request generating portion 407 is comparable to a request generation procedure.

The request generating portion 407 can also generate the region expansion request Dk as follows. For example, the request generating portion 407 may determine that there is a region capable of parking the vehicle 300 as a current parking target, but there is a subsequent parking request from one or more vehicles and no region is available for these vehicles to park. Then, the request generating portion 407 generates a region expansion request Dk. In this case, the request generating portion 407 generates the region expansion request Dk to expand the manageable region according to the number of subsequent vehicles so that all of the subsequent vehicles can be parked.

As above, it may be determined that the manageable region leaves no regions for the vehicle 300 to park. In other words, the request generating portion 407 may generate the region expansion request Dk. Then, the operation planning portion 405 suspends the generation of the server-side operation plan Dd. The operation planning portion 405 may receive an expansion determination result DI transmitted from the map server 500 via the data transmission/reception portion 401 and then restarts the generation of the server-side operation plan Dd according to the contents of the expansion determination result DI. The transmission of the expansion determination result DI by the map server 500 will be described later. The expansion determination result DI contains information such as the possibility of expanding the manageable region and information indicating the manageable region after the expansion, for example.

Specifically, the received expansion determination result DI may represent that the manageable region cannot be expanded. Then, the operation planning portion 405 continues to suspend the generation of the server-side operation plan Dd. The received expansion determination result DI may represent that the manageable region can be expanded. Then, the operation planning portion 405 restarts the generation of the server-side operation plan Dd. In this case, the operation planning portion 405 settles a target position based on the information representing the manageable region after the expansion.

Detailed Configuration of the Map Server 500

The map server 500 includes a data transmission/reception portion 501 and a database 502. The data transmission/reception portion 501 transmits and receives various data from external devices. The database 502 stores various data. The map server 500 also includes functional blocks such as an information acquisition portion 503 and a database update portion 504. The functional blocks are provided as the software. Namely, the CPU included in the map server 500 executes a computer program stored in a non-transitory tangible storage medium and performs processes corresponding to the computer program. At least some of the functional blocks may be provided as the hardware.

The information acquisition portion 503 acquires various data stored in the database 502. The information acquisition portion 503 receives the zone information request Dc transmitted from the vehicle 300 via the data transmission/reception portion 501 and then searches for various data stored in the database 502 to acquire valid zone information Dm as information about a valid zone for the temporary key Da. The information acquisition portion 503 transmits the acquired valid zone information Dm to the vehicle 300 via the data transmission/reception portion 501.

The valid zone is comparable to a travelable range where the temporary key Da enables the vehicle 300 to travel. The valid zone information is comparable to travelable range information about travelable ranges. The valid zone information Dm is previously provided by a trusted third party, for example, and is stored in the database 502. The valid zone information Dg provides map information storing valid zones where the temporary key Da can be effectively used. The valid zone can be limited to areas in the parking place where the AVP service is provided, for example.

The information acquisition portion 503 receives the region information request Dg transmitted from the vehicle 300 via the data transmission/reception portion 501, searches for various data stored in the database 502, and acquires parkable region information Df. The information acquisition portion 503 transmits the acquired parkable region information Df to the vehicle 300 via the data transmission/reception portion 501. The information acquisition portion 503 acquires the parkable region information Df from the database 502 in response to a request from the vehicle 300 and transmits the parkable region information Df to the vehicle 300. Each process performed by information acquisition portion 503 is comparable to an information acquisition procedure.

The database update portion 504 updates the database 502 and includes a region change portion 505 and a parkable region change portion 506. The region change portion 505 receives the region expansion request Dk transmitted from the parking server 400 via the data transmission/reception portion 501 and determines whether the manageable region can be expanded. When determining that the manageable region can be expanded, the region change portion 505 updates the database 502 to expand the manageable region.

The region change portion 505 updates the information stored in the database 502 to expand the manageable region in response to requests from the parking server 400. The region change portion 505 transmits an expansion determination result DI to the parking server 400 via the data transmission/reception portion 501. The expansion determination result DI contains information such as the possibility of expanding the manageable region and information indicating the manageable region after expansion. Each process performed by the region change portion 505 is comparable to a division change procedure.

The parkable region change portion 506 receives the parking position information Di transmitted from the vehicle 300 via the data transmission/reception portion 501 and then updates the database 502 to exclude the region indicated by the parking position information Di, namely, the place parked by the vehicle 300, as a region capable of parking the vehicle 300 from the unmanageable region. In other words, the parkable region change portion 506 receives the parking position information Di and then updates the information stored in the database 502 to exclude the region, indicated by the parking position information Di, as a region capable of parking the vehicle 300 from the unmanageable region.

The parkable region change portion 506 receives the starting information Dj and the parking position information Di transmitted from the vehicle 300 via the data transmission/reception portion 501. Then, the parkable region change portion 506 updates database 502 to return the region indicated by the parking position information Di, namely, the region excluded as a region capable of parking the vehicle 300 from the unmanageable region, to a region capable of parking the vehicle 300 in the unmanageable region. In other words, the parkable region change portion 506 receives the starting information Dj and the parking position information Di and then updates the information stored in database 502 to return the region, indicated by the parking position information Di, to a region capable of parking the vehicle 300 in the unmanageable region. Each process performed by the parkable region change portion 506 is comparable to a parkable region change procedure.

Specific Determination Techniques Performed by the Operation Plan Determination Portion

The description below explains specific techniques used for the server-side operation plan Dd according to the operation plan determination portion 306 of the vehicle 300. For example, the operation plan determination portion 306 determines that the server-side operation plan Dd is incorrect and may be falsified when the server-side operation plan Dd route includes a route that guides the vehicle 300 to the outside of the parking place.

Moreover, the operation plan determination portion 306 determines that the server-side operation plan Dd is incorrect and may be falsified when a vehicle such as an vehicle other than the vehicle 300 is parked at the target position of the server-side operation plan Dd. Furthermore, the operation plan determination portion 306 determines that the server-side operation plan Dd is incorrect and may be falsified when there is an obstacle hindering the driving of the vehicle 300 on the route including the target position of the server-side operation plan Dd.

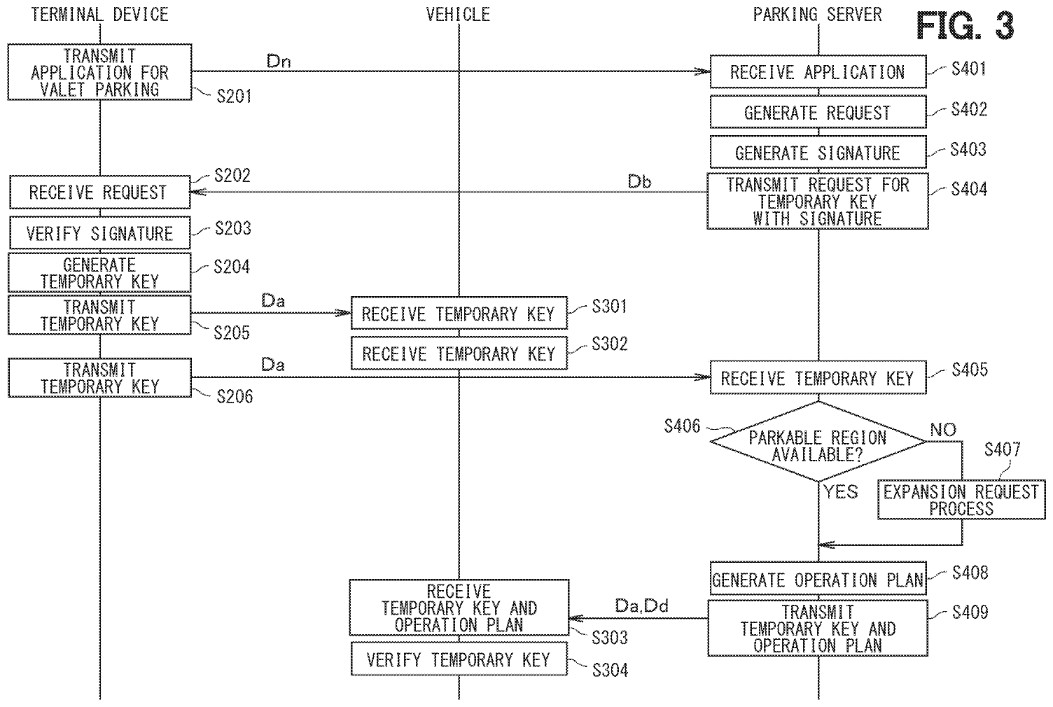

Operations of the above-described configuration will be described. By reference to FIGS. 3 through 9, the description below explains processes in the portions when the AVP is performed.

Process Flow From “Applying for AVP” to “Temporary Key Verification”

FIG. 3 illustrates processes from applying for AVP to the temporary key verification. Suppose a user manipulation applies for the valet parking. Then, at step S201, the terminal device 200 transmits application information Dn to the parking server 400. The application information Dn indicates that the valet parking is applied.

The application information Dn may contain information, useful for selecting parking slots, including the type (such as an ordinary vehicle or a light vehicle) and the vehicle height of the vehicle 300 targeted at the valet parking. The parking server 400 receives the application information Dn at step S401, generates a temporary key request Db at step S402, and supplies a signature to the temporary key request Db at step S403. At step S404, the parking server 400 transmits the temporary key request Db supplied with the signature to the terminal device 200.

The terminal device 200 receives the temporary key request Db at step S202 and verifies the authenticity of the temporary key request Db based on the signature given to the temporary key request Db at step S203. If the verification result at step S203 is true, the terminal device 200 generates a temporary key Da at step S204. Then, the terminal device 200 transmits the temporary key Da to the vehicle 300 at step S205 and transmits the temporary key Da to the parking server 400 at step S206.

The vehicle 300 receives the temporary key Da at step S301 and verifies the authenticity of the temporary key Da at step S302. The parking server 400 receives the temporary key Da at step S405 and determines at step S406 whether the manageable region of the parking place includes a region capable of parking the vehicle 300. It may be determined that the manageable region of the parking place does not include a parking slot as a region capable of parking the vehicle 300. Then, step S406 results in “NO” and control proceeds to step S407. Step S407 performs an expansion request process to request the expansion of a parkable region. The expansion request process will be described later. Step S407 is followed by step S408.

It may be determined that the manageable region of the parking place includes a parking slot as a region capable of parking the vehicle 300. Then, step S406 results in “YES” and control proceeds to step S408. At step S408, the parking server 400 generates the server-side operation plan Dd that contains a route guiding the vehicle 300 to a target position included in the manageable region. The parking server 400 selects an appropriate target position according to the availability of the parking slot. The application information Dn may contain information such as the type and the vehicle height of the vehicle 300. Then, the parking server 400 may select an optimum target position based on the information.

At step S409, the parking server 400 transmits the temporary key Da and the generated server-side operation plan Dd to the vehicle 300. The vehicle 300 receives the temporary key Da and the server-side operation plan Dd at step S303 and verifies the authenticity of the temporary key Da at step S304.

Expansion Request Process

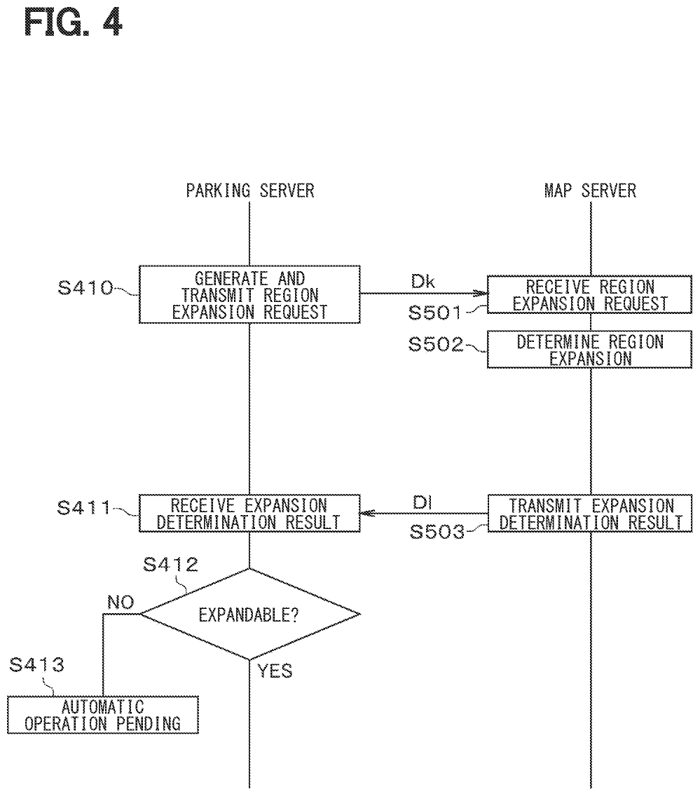

FIG. 4 illustrates the expansion request process. At step S410, the parking server 400 generates a region expansion request Dk and transmits the generated region expansion request Dk to the map server 500. The map server 500 receives the region expansion request Dk at step S501 and performs a region expansion determination at step S502 to determine whether the manageable region can be expanded.

At step S503, the map server 500 generates an expansion determination result DI based on the result of the region expansion determination and transmits the generated expansion determination result DI to the parking server 400. The parking server 400 receives the expansion determination result DI at step S411 and determines at step S412 whether the manageable region can be expanded based on the expansion determination result DI.

It may be determined that the manageable region can be expanded. Then, step S412 results in “YES.” The expansion request process terminates and control proceeds to step S408 to generate the server-side operation plan Dd. It may be determined that the manageable region cannot be expanded. Then, step S412 results in “NO” and control proceeds to step S413. Step S413 makes the automatic operation pending. In this case, the expansion request process is performed again after a lapse of the predetermined time, for example, to determine whether the manageable region can be expanded.

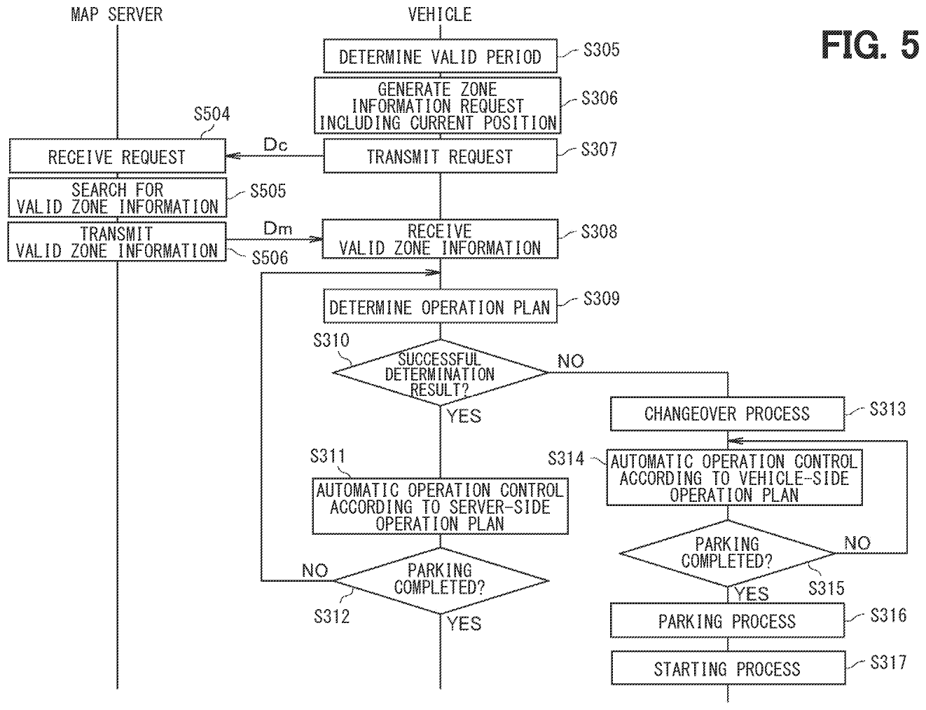

Process Flow From “Valid Period Determination” to “Starting Process” FIG. 5 illustrates a process from the validity period determination to the starting process. Suppose the verification results at steps S302 and S304 are true. Then, at step S305, the vehicle 300 determines the valid period for the temporary key Da. As a result of the determination at step S305, the vehicle 300 determines that the valid period does not expire. At step S306, the vehicle 300 generates a zone information request Dc. At step S307, the vehicle 300 transmits the zone information request Dc to the map server 500.

The map server 500 receives the zone information request Dc at step S501 and acquires the valid zone information Dm by searching for various data stored in the database 502 at step S505. The map server 500 then transmits the valid zone information Dm to the vehicle 300 at step S506. The vehicle 300 receives the valid zone information Dm at step S308 and determines the authenticity of the server-side operation plan Dd at step S309. As will be described later in detail, the vehicle 300 determines the authenticity of the server-side operation plan Dd by collating the valid zone information Dm and the server-side operation plan Dd, for example.

It may be determined that the server-side operation plan Dd is authentic (i.e., true) and unlikely to be falsified. Then, step S310 results in “YES” and control proceeds to step S311. At step S311, the vehicle 300 provides automatic operation control according to the server-side operation plan Dd. At step S312, the vehicle 300 determines whether the parking of the vehicle 300 completes. The parking of the vehicle 300 may not be completed. Then, step S312 results in “NO” and control returns to step S309. The parking of the vehicle 300 may be completed. Then, step S312 results in “YES” and the process terminates.

It may be determined that the server-side operation plan Dd is incorrect (i.e., false) and may be falsified. Then, step S310 results in “NO” and control proceeds to step S313. Step S313 provides control based on the vehicle 300 or performs the changeover process to activate vehicle-based control. The changeover process will be described later. Step S313 is followed by step 314. At step S314, the vehicle 300 performs the automatic operation control according to the vehicle-side operation plan Dh. At step S315, the vehicle 300 determines whether the parking of the vehicle 300 is completed.

The parking of the vehicle 300 may not be completed. Then, step S315 results in “NO” and control returns to step S314. The parking of the vehicle 300 may be completed. Then, step S315 results in “YES” and control proceeds to step S316. Step S316 performs a parking process required when the vehicle 300 is parked under the vehicle-based control. The parking process will be described later. Step S316 is followed by step 317 to perform a starting process required when the parked vehicle 300 starts under the vehicle-based control. The starting process will be described later. After step S317, the process terminates.

Changeover Process

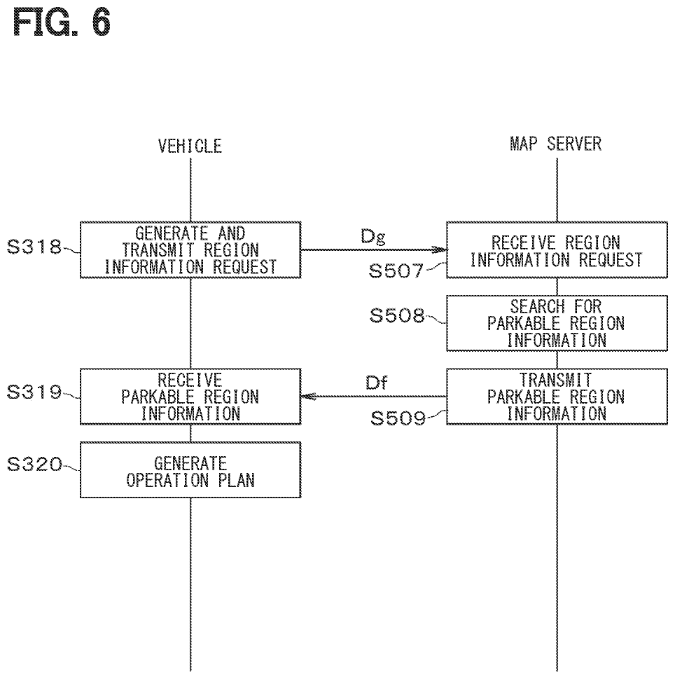

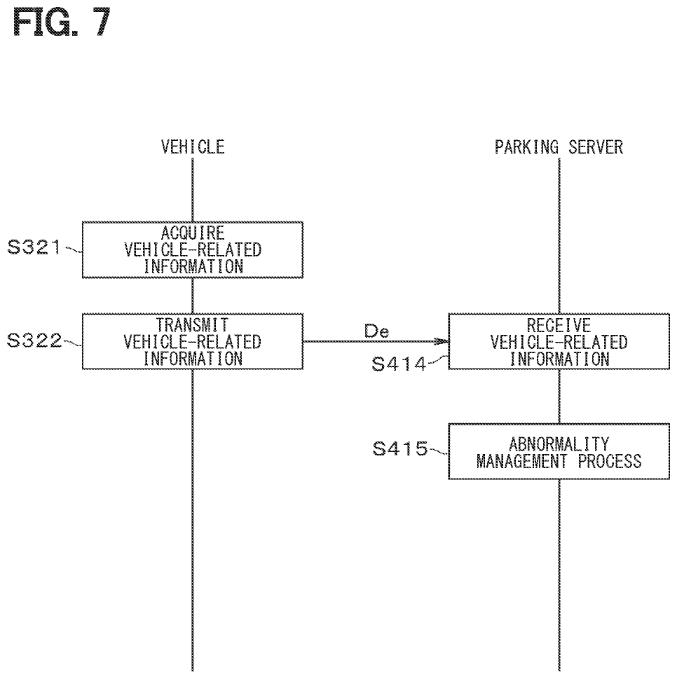

The changeover process includes two processes, a first process illustrated in FIG. 6 and a second process illustrated in FIG. 7. The first process and the second process may be performed in parallel or sequentially so that one is followed by the other.

[1] First Process

In the first process, at step S318, the vehicle 300 generates a region information request Dg and transmits the generated region information request Dg to the map server 500. The map server 500 receives the region information request Dg at step S507 and searches for various data stored in the database 502 at step S508 to acquire the parkable region information Df.

At step S509, the map server 500 transmits the parkable region information Df to the vehicle 300. The vehicle 300 receives the parkable region information Df at step S319 and, based on the parkable region information Df, generates a vehicle-side operation plan Dh containing a route guiding the vehicle 300 to a target position belonging to the unmanageable region at step S320.

[2] Second Process

In the second process, the vehicle 300 acquires the vehicle-related information De at step S321. The vehicle 300 then transmits the vehicle-related information De to the parking server 400 at step S322. At step S414, the parking server 400 receives the vehicle-related information De. At step S415, the parking server 400 classifies the abnormality based on the vehicle-related information De and the server-side operation plan Dd and performs an abnormality management process that takes action corresponding to the classification result.

Parking Process

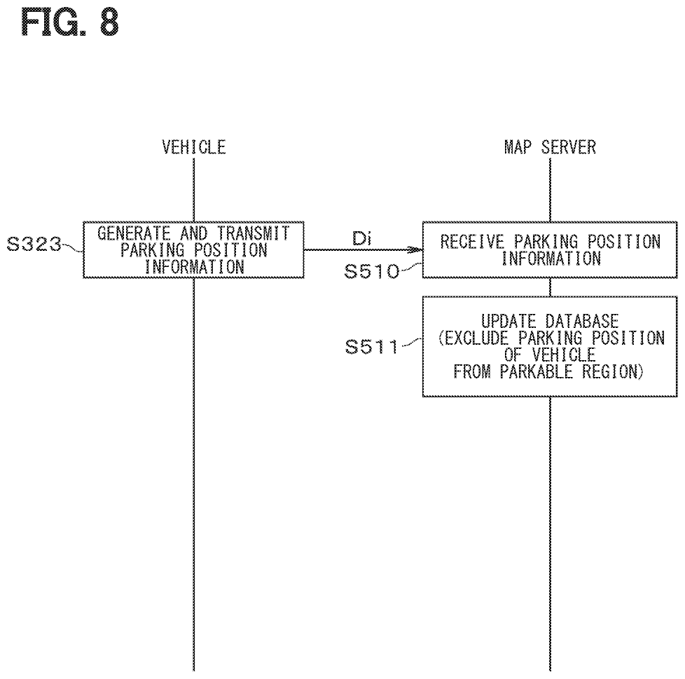

FIG. 8 illustrates the parking process. At step S323, the vehicle 300 generates parking position information Di and transmits the generated parking position information Di to the map server 500. The map server 500 receives the parking position information Di at step S510 and updates the database 502 at step S511 to exclude the region, indicated by the parking position information Di, as a parkable region from the unmanageable region.

Starting Process

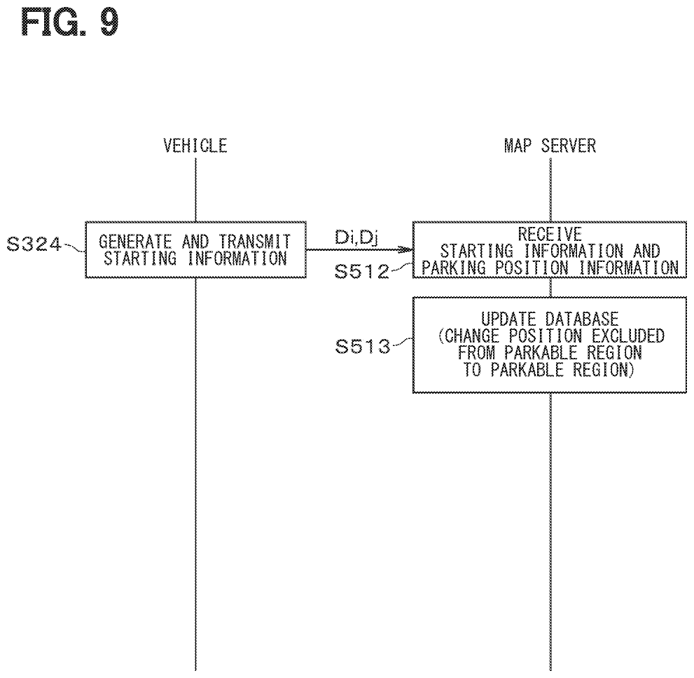

FIG. 9 illustrates the starting process. At step S324, the vehicle 300 generates starting information Dj and transmits the generated starting information Dj along with the parking position information Di to the map server 500. The map server 500 receives the starting information Dj and the parking position information Di at step S512 and updates the database 502 at step S513 to return the region, indicated by the parking position information Di, to a region capable of parking the vehicle 300 in the unmanageable region.

Cases of the Operation Plan Determination

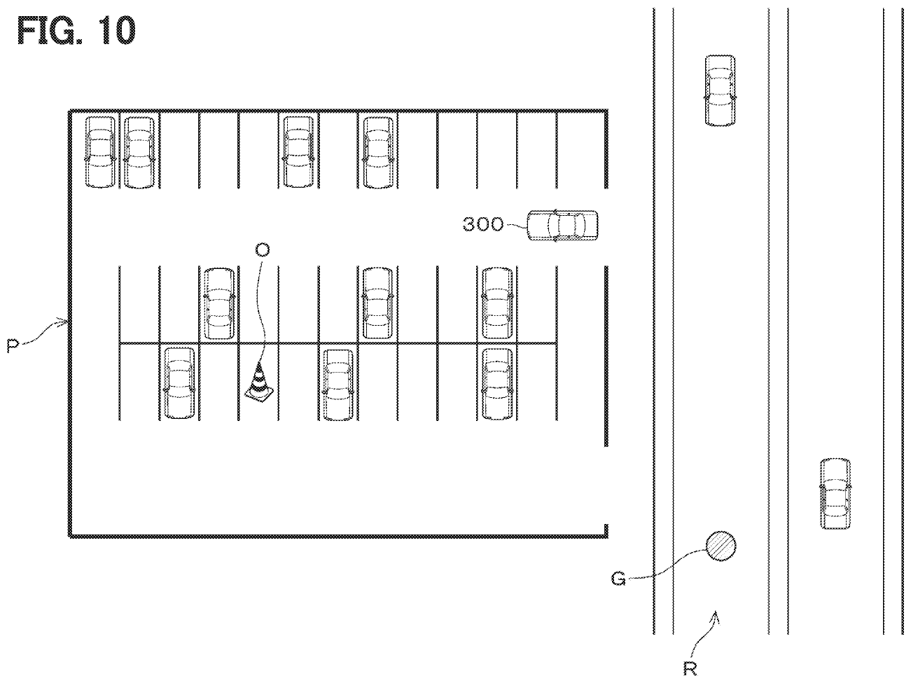

By reference to FIGS. 10 through 12, the description below explains cases of the determination on the server-side operation plan Dd. The description below provides cases of entering a parking place. The same applies to cases of exiting from a parking place. FIGS. 10 through 12 schematically illustrate multiple parking slots by dividing the parking place P with solid lines. In FIGS. 10 through 12, a hatched circle represents a target position G in the server-side operation plan Dd. A reference numeral 300 is given only to the vehicle targeted at AVP out of multiple vehicles illustrated in FIG. 10 through FIG. 12.

[1] Case 1 of Unsuccessful Determination Results

As illustrated in FIG. 10, case 1 shows that the server-side operation plan Dd specifies a region outside the parking place. Specifically, according to case 1, the target position G in the server-side operation plan Dd does not belong to the inside of the parking place P but to a road R adjacent to the parking place P.

When the process at steps S309 and S310 in FIG. 5 is performed first, the operation plan determination portion 306 can determine whether the target position G is located within the travelable range by collating the valid zone information Dm and the server-side operation plan Dd. In case 1, the operation plan determination portion 306 can determine that the target position G is located outside the travelable range and that the server-side operation plan Dd is incorrect and may be falsified before the automatic operation control for AVP starts. Consequently, case 1 activates the vehicle-based control without providing the automatic operation control according to the server-side operation plan Dd.

In case 1, the abnormality processing portion 406 of the parking server 400 is assumed to operate as follows. When the position information such as the target position is considered to be abnormal, the abnormal processing portion 406 determines that a malicious third party, for example, hacked the communication of the vehicle 300. Based on the vehicle-related information De, the abnormality processing portion 406 records the information around the vehicle 300 and the time of abnormality occurrence, for example, when such an abnormality is detected.

[2] Case 2 of Unsuccessful Determination Results

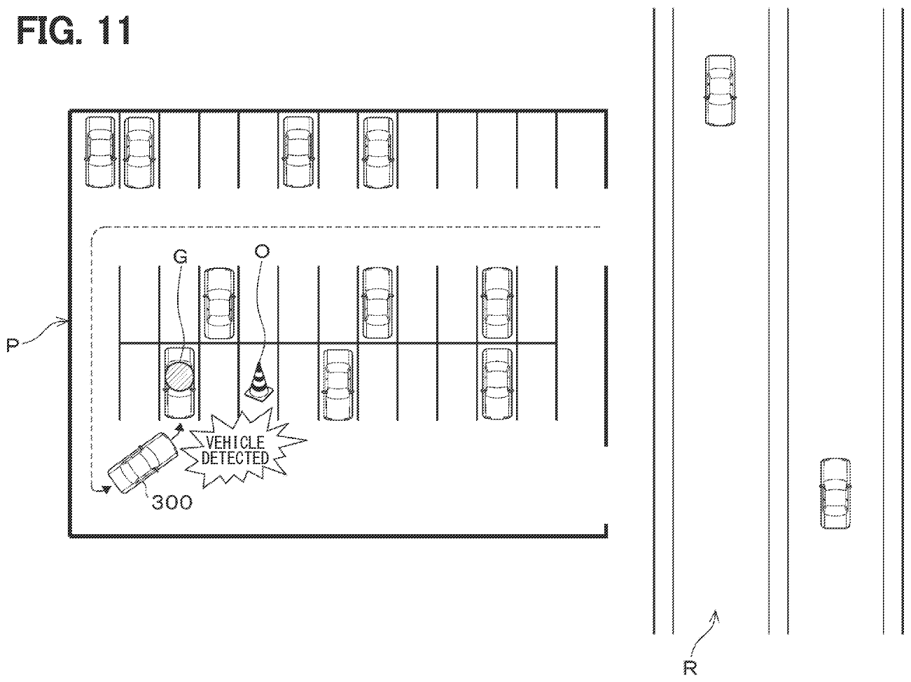

As illustrated in FIG. 11, case 2 shows that another vehicle parks at the parking space specified in the server-side operation plan Dd. In case 2, the target position G in the server-side operation plan Dd belongs to the inside of the parking place P, but another vehicle already parks at the parking slot represented by the target position G. As illustrated in FIG. 5, the operation plan determination portion 306 continues the process at steps S309 and S310 to determine the server-side operation plan Dd until parking is completed even after activation of the automatic operation control according to the server-side operation plan Dd.

In case 2, the operation plan determination portion 306 can determine that the server-side operation plan Dd is incorrect and may be falsified under the condition that the vehicle 300 approaches the target position G after activation of the automatic operation control and detects another vehicle stopped at the target position G. Images from a camera mounted on the vehicle 300 can be used to detect another vehicle stopped at the target position G. In case 2, the automatic operation control according to the server-side operation plan Dd is provided once and then changes to the vehicle-based control.

In case 2, the abnormality processing portion 406 of the parking server 400 is assumed to operate as follows. As above, the location information such as the target position is considered normal, but another unintended vehicle stops at the target position. Then, the abnormality processing portion 406 determines that a malicious third party, for example, hacked the communication for another vehicle or the vehicle 300.

Based on all the transmitted server-side operation plans, the abnormality processing portion 406 determines which communication for another stopped vehicle or the vehicle 300 is hacked. In other words, it is determined whether another vehicle or the vehicle 300 is abnormal. Such a determination can be made as follows, for example. The abnormality processing portion 406 searches the transmitted server-side operation plans for a server-side operation plan that contains the same target position as the position where another vehicle currently stops.

The transmission of the server-side operation plan may be targeted at another vehicle. Then, the abnormality processing portion 406 determines that the vehicle 300 is abnormal. The transmission of the server-side operation plan may be targeted at the vehicle 300. Then, the abnormal processing portion 406 determines that another vehicle is abnormal. In this case, there may be a situation where another vehicle received an incorrect operation plan and provided the automatic operation control according to the incorrect operation plan, but the parking slot specified as the target position was accidentally available, enabling the parking.

Subsequently, based on the vehicle-related information De, the abnormality processing portion 406 records the information around the vehicle 300 and the time of abnormality occurrence concerning the detection of the abnormality, for example, and notifies the recorded information to a manager of the parking place. As above, the abnormality processing portion 406 may determine that another vehicle is abnormal. Then, it may be favorable to retry the automatic operation control based on the parking server 400. In this case, control returns to step S408 in FIG. 3. The operation planning portion 405 of the parking server 400 may regenerate the server-side operation plan Dd containing another target position and perform the subsequent process.

[3] Case 3 of Unsuccessful Determination Results

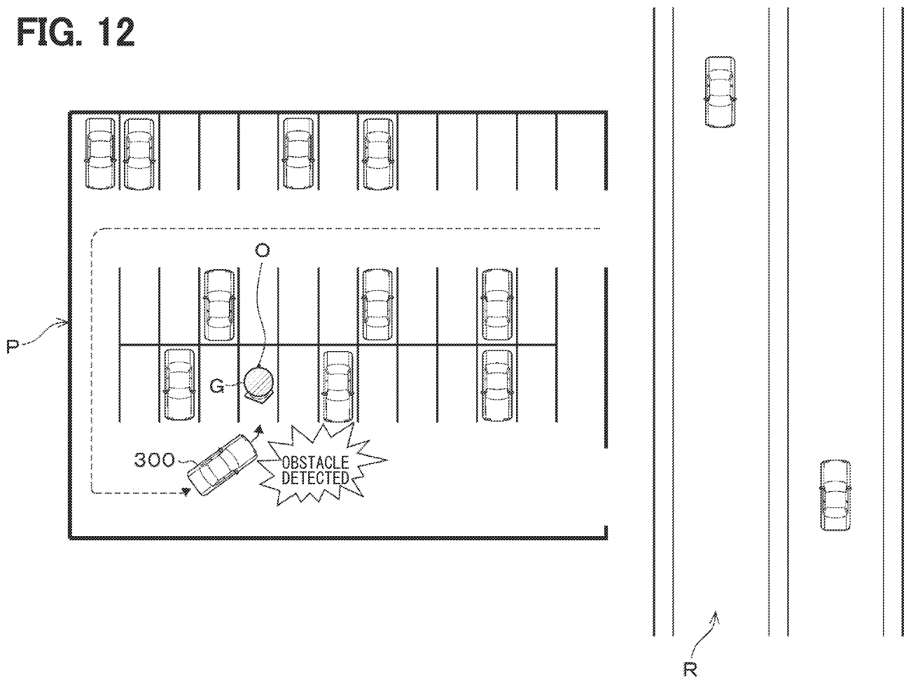

As illustrated in FIG. 12, case 3 shows that there is an obstacle 0, such as a pylon, at the parking space specified in the server-side operation plan Dd. In case 3, the target position G in the server-side operation plan Dd belongs to the inside of the parking place P, but the obstacle O exists at the parking slot represented by the target position G. As illustrated in FIG. 5, the operation plan determination portion 306 continues the process at steps S309 and S310 to determine the server-side operation plan Dd until parking is completed even after activation of the automatic operation control according to the server-side operation plan Dd.

In case 3, the operation plan determination portion 306 can determine that the server-side operation plan Dd is incorrect and may be falsified under the condition that, after the automatic operation control starts, the vehicle 300 approaches the target position G and then detects the obstacle 0 at the target position G. Images from a camera mounted on the vehicle 300 can be used to detect the obstacle 0 at the target position G. In case 3, the automatic operation control according to the server-side operation plan Dd is provided once and then changes to the vehicle-based control.

In case 3, the abnormality processing portion 406 of the parking server 400 is assumed to operate as follows. The abnormality processing portion 406 determines a problem in the parking place when the position information such as the target position is normal, but the obstacle 0 exists at the target position. Based on the vehicle-related information De, the abnormality processing portion 406 records the information around the vehicle 300 and the time of abnormality occurrence concerning the detection of the abnormality, for example, and notifies the recorded information to a manager of the parking place.

Because of the problem in the parking place, it may be favorable to retry the automatic operation control based on the parking server 400. In this case, control returns to step S408 in FIG. 3. The operation planning portion 405 of the parking server 400 may regenerate the server-side operation plan Dd containing another target position and perform the subsequent process. While case 3 illustrates that the obstacle O exists at the target position G, the same process is performed when the obstacle O exists somewhere on routes included in the server-side operation plan Dd. However, a retrial of the automatic operation control based on the parking server 400 requires generating the server-side operation plan Dd that includes a route to avoid the obstacle O.

The present embodiment described above provides the following effects.

The operation planning portion 405 of the parking server 400 generates the server-side operation plan Dd containing a route that guides the vehicle 300 to the target position included in the manageable region managed by the parking server 400. The server-side operation plan Dd is transmitted to vehicle 300. The operation plan determination portion 306 of the vehicle 300 determines whether the server-side operation plan Dd is incorrect, namely, whether the server-side operation plan Dd is likely to be falsified. The automatic operation control portion 309 of the vehicle 300 provides the automatic operation control according to the server-side operation plan Dd.

The operation plan determination portion 306 may determine that the server-side operation plan Dd is incorrect or may be falsified. Then, the information transmission portion 307 of the vehicle 300 acquires the vehicle-related information De related to the vehicle 300 and transmits the vehicle-related information De to the parking server 400. The abnormality processing portion 406 of the parking server 400 receives the vehicle-related information De. Based on the vehicle-related information De and the server-side operation plan Dd, the abnormality processing portion 406 classifies the abnormality that occurred around the vehicle 300 due to the server-side operation plan Dd that is incorrect or may be falsified. The abnormality processing portion 406 performs an abnormality management process corresponding to the classification result.

According to the above-described configuration, the abnormality processing portion 406 of parking server 400 performs the abnormality management process when a malicious third party intercepts the communication between the parking server 400 and the vehicle 300 and falsifies the server-side operation plan Dd. It is possible to minimize the damage caused by the automatic operation control based on the falsified server-side operation plan Dd. The above-described configuration provides an excellent effect of improving the system security.

The information acquisition portion 503 of the map server 500 acquires the parkable region information Df from the database 502 in response to a request from the vehicle 300. The parkable region information Df provides a region enabling the vehicle 300 to park in an unmanageable region that is not managed by the parking server 400. The information acquisition portion 503 transmits the parkable region information Df to the vehicle 300. The operation plan determination portion 306 may determine that the server-side operation plan Dd is incorrect. Then, the request generating portion 305 of the vehicle 300 requests the map server 500 to transmit the parkable region information Df. The operation planning portion 308 of the vehicle 300 receives the parkable region information Df and, based on the parkable region information Df, generates the vehicle-side operation plan Dh including a route that guides the vehicle 300 to the target position included in the unmanageable region.

The operation plan determination portion 306 may determine that the server-side operation plan Dd is correct. Then, the automatic operation control portion 309 of the vehicle 300 provides the automatic operation control according to the server-side operation plan Dd. The operation plan determination portion 306 may determine that the server-side operation plan Dd is incorrect. Then, the automatic operation control portion 309 provides the automatic operation control according to the vehicle-side operation plan Dh.

According to the above-described configuration, the vehicle-based automatic operation control enables automatic parking at a target position in the unmanageable region that is not managed by the parking server 400 even if a malicious third party intercepts the communication between the parking server 400 and the vehicle 300 and falsifies the server-side operation plan Dd. The vehicle 300 can be parked normally. It is possible to provide an excellent effect of improving the system security.

Due to the above-mentioned abnormality, the vehicle 300 may change to the vehicle-based automatic operation control. Then, the parking place includes a mix of the vehicle 300 configured for vehicle-based automatic parking and the vehicle 300 configured for automatic parking based on the parking server 400. In this case, regions in the parking place are divided into the manageable region managed by the parking server 400 and the unmanageable region not managed by the same. Even if such an abnormality occurs, the present embodiment can provide smooth automatic parking without complicating the control over the entire parking place.

The request generating portion 407 of the parking server 400 may determine the unavailability of a region capable of parking the vehicle 300 in the manageable region, and then requests the map server 500 to expand the manageable region. In response to the request from the parking server 400, the region change portion 505 of the map server 500 updates the information stored in the database 502 to expand the manageable region.

The unmanageable region is used only in an abnormal state to provide the vehicle-based automatic operation control and is not used in the normal state. When the manageable region in the parking place is too full to leave the parking place, for example, the above-described configuration can effectively use the unmanageable region not used in the normal state. It is possible to reduce the unmanageable region and allocate the reduced space as a manageable region. The AVP system 1 according to the present embodiment can provide automatic parking that effectively uses the limited space in the parking place.

The automatic operation control portion 309 provides automatic operation control according to the vehicle-side operation plan Dh to complete parking of the vehicle 300 at the target position in the unmanageable region. Then, the parking position transmission portion 310 of the vehicle 300 transmits the parking position information Di indicating the parked position to the map server 500. The parkable region change portion 506 of the map server 500 receives the parking position information Di, then updates the information stored in the database 502 to exclude the region, indicated by the parking position information Di, from a region in the unmanageable region where parking of the vehicle 300 is possible.

The above-described configuration can normally park multiple vehicles 300 without overlap between the corresponding target positions even if multiple vehicles 300 simultaneously change to the vehicle-based automatic operation control due to occurrence of an abnormality, for example. It is possible to moreover improve the system security.

The vehicle 300 parked at the target position in the unmanageable region may start to exit from the parking place. Then, the parking position transmission portion 310 of the vehicle 300 transmits the starting information Dj and the parking position information Di to the map server 500. The starting information Dj indicates that the vehicle 300 starts. The parkable region change portion 506 of the map server 500 receives the starting information Dj and the parking position information Di and updates the information stored in the database 502 to return the region, indicated by the parking position information Di, as a region capable of parking the vehicle 300 to the unmanageable region.

The operation plan determination portion 306 of the vehicle 300 determines that the server-side operation plan Dd is false if the server-side operation plan Dd includes a route that guides the vehicle 300 to a place outside of the parking place. As above, when the server-side operation plan Dd is determined to be false, the vehicle 300 changes to the vehicle-based automatic operation control. It is possible to prevent the worst-case scenario where a malicious third party hacks the vehicle 300, guides the vehicle 300 to a location outside of the parking place contrary to the user's intentions, and steals it, for example.

The operation plan determination portion 306 of the vehicle 300 determines that the server-side operation plan Dd is false if an vehicle other than the vehicle 300 stops at the target position specified by the server-side operation plan Dd. As above, when the server-side operation plan Dd is determined to be false, the vehicle 300 changes to the vehicle-based automatic operation control. It is possible to prevent a situation where another vehicle parked at the target position continuously disables the vehicle 300 from being parked.

The operation plan determination portion 306 of the vehicle 300 determines that the server-side operation plan Dd is false if the obstacle 0 exists on the route including the target position of the server-side operation plan Dd and hinders the vehicle 300 from traveling. As above, when the server-side operation plan Dd is determined to be false, the vehicle 300 changes to the vehicle-based automatic operation control. It is possible to prevent a situation where an obstacle on the route or the target position continuously disables the vehicle 300 from being parked.

### Second Embodiment

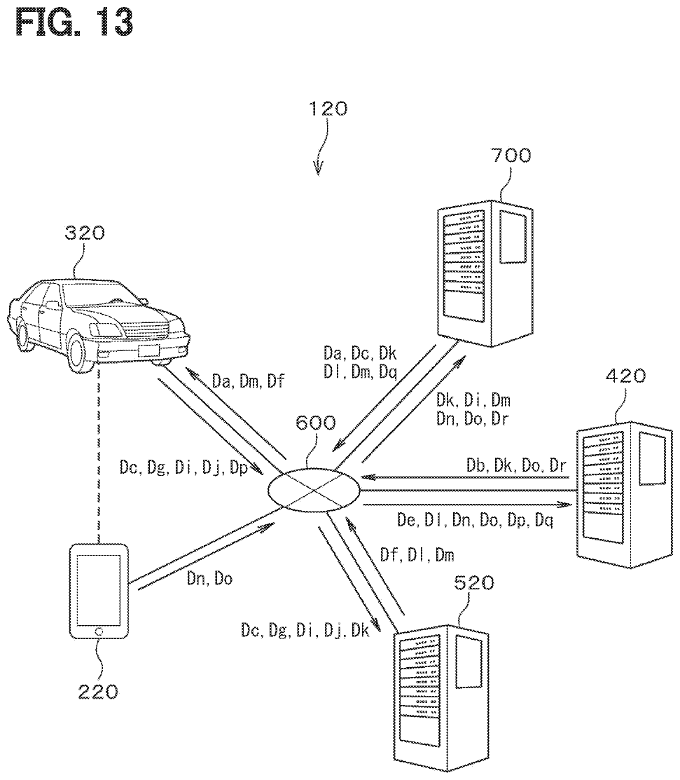

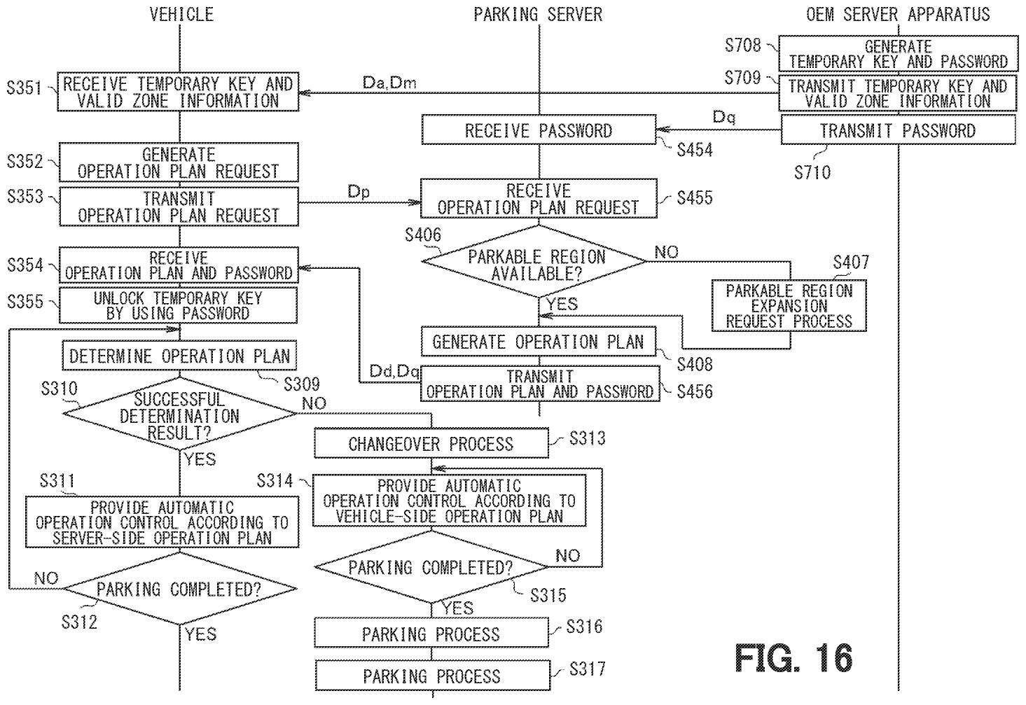

The second embodiment will be described by reference to FIGS. 13 through 18.

Overall Configuration of an Automatic Valet Parking System 120

The AVP system 120 according to the present embodiment illustrated in FIG. 13 differs from the AVP system 100 according to the first embodiment in the following. For example, the terminal device 200, the vehicle 300, the parking server 400, and the map server 500 are replaced by a terminal device 220, an vehicle 320, a parking server 420, and a map server 520. An OEM server apparatus 700 is added.

The terminal device 220, the parking server 420, and the OEM server apparatus 700 are communicably connected via the network 600. The vehicle 320, the parking server 420, and the OEM server apparatus 700 are communicably connected via the network 600. The OEM server apparatus 700, the parking server 420, and the map server 520 are communicably connected via the network 600. The AVP system 120 is configured so that data can be transmitted and received among the terminal device 220, the vehicle 320, the parking server 420, the map server 520, and the OEM server apparatus 700.

The OEM server apparatus 700 is operated by a vehicle manufacturer or OEM, as a manufacturer of the vehicle 320. In this case, the OEM directly manages the OEM server apparatus 700. The OEM server apparatus 700 can be not only managed under a confidentiality agreement with the OEM but also indirectly managed by another company outsourced by the OEM, for example.

Detailed Configuration of the Terminal Device 220

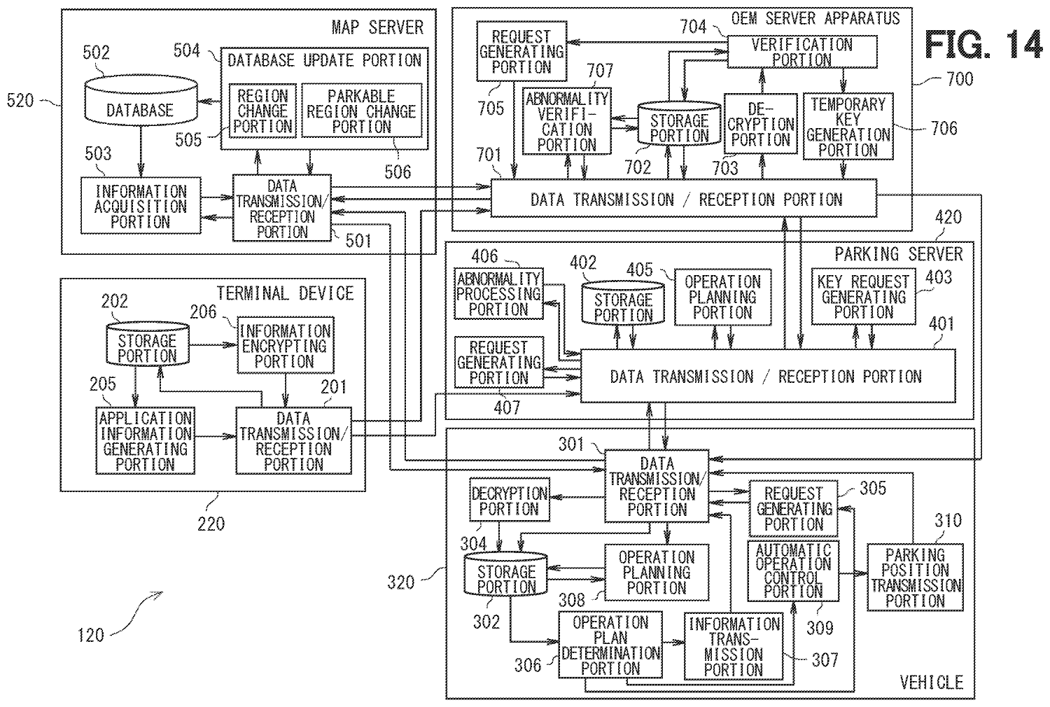

As will be described in detail later, the OEM server apparatus 700 generates the temporary key Da only when AVP is performed. As illustrated in FIG. 14, the terminal device 220 according to the present embodiment changes the configuration of functional blocks for the terminal device 200 according to the first embodiment. Namely, the terminal device 220 according to the present embodiment includes functional blocks such as an application information generating portion 205 and an information encrypting portion 206.

The application information generating portion 203 generates the application information Dn about the application for valet parking. The application information Dn includes user information, information about a parking place to apply for, and parking place usage time information, for example. The application information generating portion 203 transmits the generated application information Dn to the parking server 420 and the OEM server apparatus 700 via the data transmission/reception portion 201.

In this case, the storage portion 202 stores vehicle information about the vehicle 320. The vehicle information includes information about the car model, the chassis frame number, the size such as a vehicle height, and information about the user who owns the vehicle. The information about the car model may indicate an ordinary vehicle or a light vehicle, for example. The information such as the car model and the size is helpful in selecting parking slots. The information encrypting portion 206 reads the vehicle information from the storage portion 202 and encrypts the vehicle information. The information encrypting portion 206 transmits encrypted vehicle information Do to the parking server 420 and the OEM server apparatus 700 via the data transmission/reception portion 201.

The application information Dn and the vehicle information Do are simultaneously transmitted to the parking server 420. The application information Dn and the vehicle information Do are simultaneously transmitted to the OEM server apparatus 700. The application information Dn transmitted to the OEM server apparatus 700 just needs to contain at least information about the parking place to apply for. In the description below, the authentication information may generically signify the application information Dn and the vehicle information Do transmitted to the OEM server apparatus 700.

Detailed Configuration of the Vehicle 320

The vehicle 320 according to the present embodiment changes the configuration of functional blocks for the vehicle 300 according to the first embodiment. Namely, the vehicle 320 according to the present embodiment includes functional blocks such as a request generating portion 305, an operation plan determination portion 306, an information transmission portion 307, an operation planning portion 308, an automatic operation control portion 309, a parking position transmission portion 310, and a decryption portion 311.

The request generating portion 305 receives the temporary key Da and the valid zone information Dm transmitted from the OEM server apparatus 700 via the data transmission/reception portion 301 and then generates an operation plan request Dp that requests the generation of an operation plan. The transmission of the temporary key Da and the valid zone information Dm by the OEM server apparatus 700 will be described later. The request generating portion 305 transmits the generated operation plan request Dp to the parking server 420 via the data transmission/reception portion 301.

The decryption portion 311 receives the temporary key Da transmitted from the OEM server apparatus 700 and the password Dq transmitted from the parking server 420 and then verifies whether the combination is valid. The transmission of the password Dq by the parking server 420 will be described later. If the combination is valid, the decryption portion 311 unlocks or validates the temporary key Da by using the password Dq.

The automatic operation control portion 309 receives the temporary key Da transmitted from the OEM server apparatus 700 via the data transmission/reception portion 301 and the server-side operation plan Dd and the password Dq transmitted from the parking server 420 via the data transmission/reception portion 301. Then, the automatic operation control portion 309 provides automatic operation control according to the server-side operation plan Dd. The verification result from the decryption portion 311 may indicate a valid combination of the temporary key Da and the password Dq. Namely, the decryption portion 311 may validate the temporary key Da. Then, the automatic operation control portion 309 determines that the server-side operation plan Dd transmitted with the password Dq is available, and provides automatic operation control according to the server-side operation plan Dd.

Detailed Configuration of the Parking server 420

The parking server 420 according to the present embodiment changes the configuration of functional blocks for the parking server 400 according to the first embodiment. Namely, the parking server 420 according to the present embodiment includes functional blocks such as a key request generating portion 403, an operation planning portion 405, an abnormality processing portion 406, and a request generating portion 407.

The key request generating portion 403 receives the application information Dn and the encrypted vehicle information Do transmitted from the terminal device 220 via the data transmission/reception portion 401 and then generates a temporary key request Db requesting the generation of the temporary key Da. The key request generating portion 403 transmits the generated temporary key request Db and the encrypted vehicle information Do to the OEM server apparatus 700 via the data transmission/reception portion 401.

The operation planning portion 405 receives the operation plan request Dp transmitted from the vehicle 320 via the data transmission/reception portion 401 and then generates a server-side operation plan Dd. The operation planning portion 405 receives the password Dq transmitted from the OEM server apparatus 700 via the data transmission/reception portion 401 and then transmits the password Dq along with the generated server-side operation plan Dd to the vehicle 320 via the data transmission/reception portion 401.

The abnormality processing portion 406 classifies an abnormality occurring around the vehicle 320 due to the server-side operation plan Dd based on the vehicle-related information De and the server-side operation plan Dd and then transmits abnormality information Dr, indicating a result of the abnormality classification, to the OEM server apparatus 700 via the data transmission/reception portion 401. The request generating portion 407 transmits the generated region expansion request Dk to the map server 520 via the OEM server apparatus 700.

Detailed Configuration of the OEM Server Apparatus 700

The OEM server apparatus 700 includes a data transmission/reception portion 701 and a storage portion 702. The data transmission/reception portion 701 transmits and receives various data from external devices. The storage portion 702 stores various data. The storage portion 702 stores various predetermined information and various information received via the data transmission/reception portion 701. The OEM server apparatus 700 includes functional blocks such as a decryption portion 703, a verification portion 704, a request generating portion 705, a temporary key generation portion 706, and an abnormality verification portion 707.

The functional blocks are provided as the software. Namely, the CPU included in the OEM server apparatus 700 executes a computer program stored in a non-transitory tangible storage medium and performs processes corresponding to the computer program. At least some of the functional blocks may be provided as the hardware.

The decryption portion 703 receives the encrypted vehicle information Do transmitted from the terminal device 220 via the data transmission/reception portion 701 and then decrypts the vehicle information Do. The decryption portion 703 receives the encrypted vehicle information Do transmitted from the parking server 400 via the data transmission/reception portion 701 and then decrypts the vehicle information Do. The verification portion 704 receives the application information Dn transmitted from the terminal device 200 via the data transmission/reception portion 701 and the temporary key request Db transmitted from the parking server 420 via the data transmission/reception portion 701. Then, the verification portion 704 verifies the authenticity of the temporary key request Db.

Specifically, the verification portion 704 verifies the authenticity of the temporary key request Db by verifying the information transmitted from the terminal device 220 and the parking server 420 as follows. Namely, the verification portion 704 verifies a match between the vehicle information Do transmitted from the terminal device 200 and the vehicle information Do transmitted from the parking server 420. Moreover, the verification portion 704 verifies a match between the parking place information, namely, between the parking place to apply for included in the application information Dn transmitted from the terminal device 220 and the parking place including the parking server 420 that transmits the temporary key request Db.

The verification portion 704 determines that the temporary key request Db is authentic if the vehicle information Do matches and the parking place information matches. The verification portion 704 determines that the temporary key request Db is unauthentic if one or both of the vehicle information Do and the parking place information do not match. The request generating portion 705 generates a zone information request Dc to transmit the valid zone information Dm. The request generating portion 705 transmits the generated zone information request Dc to the map server 520 via the data transmission/reception portion 701.

The temporary key generation portion 706 generates a temporary key Da if the verification result from the verification portion 704 is true. The temporary key generation portion 706 receives the valid zone information Dm transmitted from the map server 520 via the data transmission/reception portion 701 and then transmits the received valid zone information Dm along with the generated temporary key Da to the vehicle 320 via the data transmission/reception portion 701. When generating the temporary key Da, the temporary key generation portion 706 also generates a password Dq to validate the temporary key Da. The password Dq may be available as a one-time password, for example. The temporary key generation portion 706 transmits the generated password Dq to the vehicle 320 via the parking server 420.

The abnormality verification portion 707 receives the abnormality information Dr transmitted from the parking server 420 via the data transmission/reception portion 701. Based on the abnormality information Dr, the abnormality verification portion 707 then performs an abnormality verification process to verify the abnormality that occurred around the vehicle 320. Each action performed by the abnormality verification portion 707 is comparable to an abnormality verification procedure.

Detailed Configuration of the Map server 520

The information acquisition portion 503 of the map server 520 according to the present embodiment receives the zone information request Dc transmitted from the OEM server apparatus 700 via the data transmission/reception portion 501. Then, the information acquisition portion 503 searches for various data stored in the database 502 to acquire the valid zone information Dm. The information acquisition portion 503 transmits the acquired valid zone information Dm to the OEM server apparatus 700 via the data transmission/reception portion 501. In this case, the region change portion 505 transmits the expansion determination result DI to the parking server 420 via the OEM server apparatus 700.

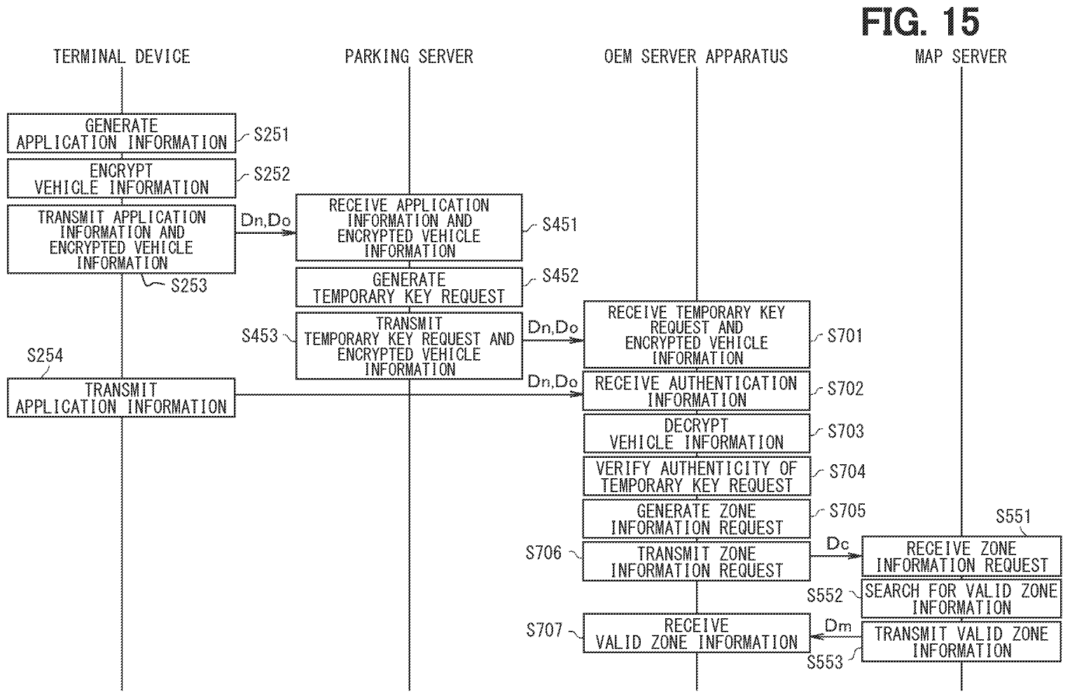

Operations of the above-described configuration will be described. By reference to FIGS. 15 through 18, the description below explains processes in the components when the AVP is performed. The processes illustrated in FIGS. 15 to 18 may include the same step numbers as the first embodiment to represent the same contents.

Process Flow From “Applying for AVP” to “Receiving the Valid Zone Information”

FIG. 15 illustrates processes from applying for AVP to receiving the valid zone information. Suppose a user manipulation applies for the valet parking. Then, at step S251, the terminal device 220 recognizes the manipulation for the application and generates application information Dn according to the manipulation content.

At step S252, the terminal device 220 encrypts the vehicle information Do. At step S253, the terminal device 220 transmits the application information Dn and the encrypted vehicle information Do to the parking server 420. At step S254, the terminal device 220 transmits the application information Dn and the encrypted vehicle information Do, namely, the authentication information about the valet parking application, to the OEM server apparatus 700.

At step S451, the parking server 420 receives the application information Dn and the encrypted vehicle information Do and then proceeds to step S452 to generate a temporary key request Db. At step S453, the parking server 420 transmits the temporary key request Db and the encrypted vehicle information Do to the OEM server apparatus 700. According to the present embodiment, the OEM server apparatus 700 can decrypt the vehicle information Do encrypted by the terminal device 220, but the parking server 420 cannot. Therefore, the parking server 420 cannot identify the contents of the vehicle information Do that is transmitted from the terminal device 220 and may include personal information.

The OEM server apparatus 700 receives the temporary key request Db and the encrypted vehicle information Do at step S701, receives the authentication information at step S702, and then proceeds to step S703 to decrypt the vehicle information Do. At step S704, the OEM server apparatus 700 verifies the authenticity of the temporary key request Db. The OEM server apparatus 700 performs the process at step S705 and later only when the temporary key request Db is determined to be authentic.

The temporary key request Db may be determined to be unauthentic. Then, the OEM server apparatus 700 transmits an error message to the terminal device 220, for example, to notify the user that the temporary key Da cannot be generated and the AVP is unavailable. Then, the entire process in the AVP system 120 terminates. At step S705, the OEM server apparatus 700 generates a zone information request Dc. At step S706, the OEM server apparatus 700 transmits the zone information request Dc to the map server 500.

At step S551, the map server 500 receives the zone information request Dc and then proceeds to step S552 to search for various data stored in the database 502 and acquire the valid zone information Dm. At step S553, the map server 500 transmits the valid zone information Dm to the OEM server apparatus 700. At step S707, the OEM server apparatus 700 receives the valid zone information Dm.

Process Flow From “Generating a Temporary Key” to “Starting Process”

FIG. 15 illustrates processes from “generating a temporary key” to “starting process.” As above, the OEM server apparatus 700 receives the valid zone information Dm at step S707 and then proceeds to step S708 to generate the temporary key Da and the password Dq. At step S709, the OEM server apparatus 700 transmits the temporary key Da and the valid zone information Dm to the vehicle 320. At step S710, the OEM server apparatus 700 transmits the password Dq to the parking server 420.

The vehicle 320 receives the temporary key Da and the valid zone information Dm at step S351 and then proceeds to step S352 to generate an operation plan request Dp. At step S353, the vehicle 320 transmits the operation plan request Dp to the parking server 420. The parking server 420 receives the password Dq at step S454, receives the operation plan request Dp at step S455, and then proceeds to step S406.

The contents of the process at steps S406 through S408 are equal to those of the first embodiment, and a description is omitted for brevity. The contents of the expansion request process at step S407 differ from those of the first embodiment and will be described later. Step S408 is followed by step S456. At step S456, the parking server 420 transmits the server-side operation plan Dd and the password Dq to the vehicle 320. At step S354, the vehicle 320 receives the server-side operation plan Dd and the password Dq and then proceeds to step S355 to verify whether the combination of the temporary key Da and the password Dq is valid. The verification result may indicate that the combination is valid. Then, the vehicle 320 unlocks the temporary key Da by using the password Dq.

The verification result may indicate that the combination of the temporary key Da and the password Dq is invalid. Then, the vehicle 320 transmits an error message to the terminal device 220, for example, to notify the user that the temporary key Da cannot be unlocked and the AVP is unavailable. Then, the entire process in the AVP system 120 terminates.

The vehicle 320 may unlock the temporary key Da by using the password Dq and then proceeds to step S309. The contents of the process at steps S309 through S317 are equal to those of the first embodiment, and a description is omitted for brevity. The contents of the second process of the expansion request process at step S313 differ from those of the first embodiment and will be described later.

Expansion Request Process

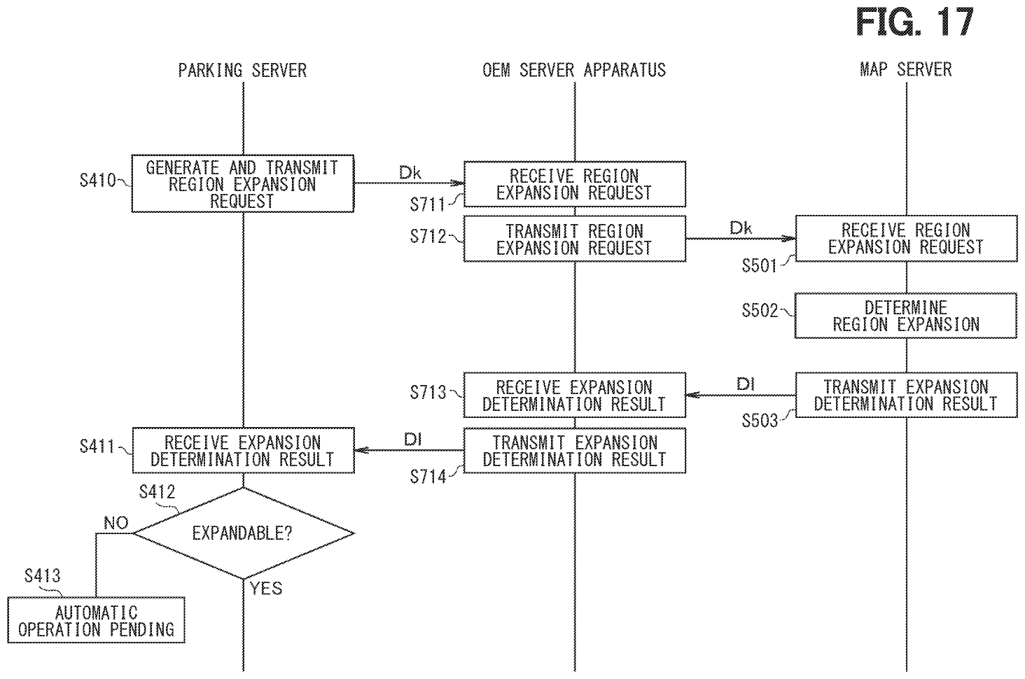

FIG. 17 illustrates the expansion request process according to the present embodiment. At step S410, the parking server 420 generates a region expansion request Dk and transmits the generated region expansion request Dk to the OEM server apparatus 700. The OEM server apparatus 700 receives the region expansion request Dk at step S711 and transmits the received region expansion request Dk to the map server 520 at step S712.

The map server 520 receives the region expansion request Dk at step S501 and performs the region expansion determination at step S502 to determine whether the manageable region can be expanded. At step S503, the map server 520 generates an expansion determination result DI based on the result of the region expansion determination and transmits the generated expansion determination result DI to the OEM server apparatus 700.

The OEM server apparatus 700 receives the expansion determination result DI at step S713 and transmits the received expansion determination result DI to the parking server 420 at step S714. At step S411, the parking server 420 receives the expansion determination result DI and proceeds to step S412. The contents of the process at steps S412 and S413 are equal to those of the first embodiment, and a description is omitted for brevity.

Second Process of the Changeover Process

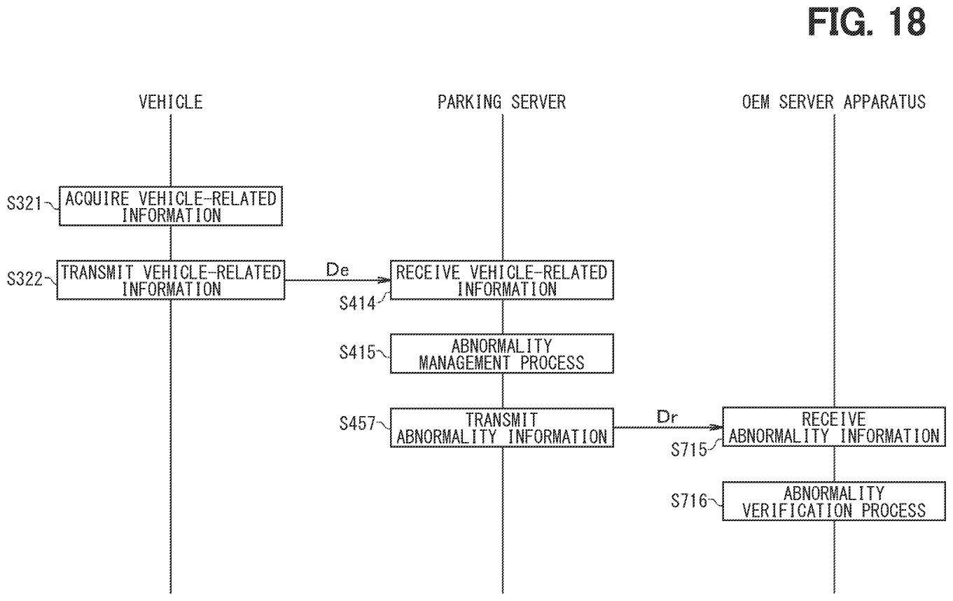

As illustrated in FIG. 18, the second process according to the present embodiment differs from the second process of the first embodiment in the addition of the process after the parking server 420 performs the process at step S415. After step S415, the parking server 420 proceeds to step S457 and transmits the abnormality information Dr to the OEM server apparatus 700. The OEM server apparatus 700 receives the abnormality information Dr at step S715 and performs the abnormality verification process based on the abnormality information Dr at step S716.

Cases of the Abnormality Management Process and the Abnormality Verification Process

The description below explains specific cases concerning the abnormality management process performed by the parking server 420 and the abnormality verification process performed by the OEM server apparatus 700. The description is related to the contents of the processes corresponding to cases 1 and 2 described in the first embodiment by reference to FIGS. 10 and 11. Case 3 concerns an issue with the parking place. Therefore, the OEM server apparatus 700 does not perform the abnormality verification process. Similar to the first embodiment, only the parking server 420 performs the abnormality management process.

[1] Case 1

In case 1, the abnormality processing portion 406 of the parking server 420 and the abnormality verification portion 707 of the OEM server apparatus 700 are assumed to operate as follows. Similar to the first embodiment, the abnormality processing portion 406 determines that a malicious third party, for example, hacked the communication of the vehicle 300.

The abnormality processing portion 406 generates the abnormality information Dr containing information around the vehicle 320 at the detection of the abnormality, the chassis frame number and the part number of the vehicle 320, and the time of abnormality occurrence, for example. The abnormality processing portion 406 transmits the generated abnormality information Dr to the OEM server apparatus 700. The abnormality verification portion 707 receives the abnormality information Dr transmitted from the parking server 420 and determines that an abnormality occurs on the vehicle 320 that received the server-side operation plan Dd. Then, the abnormality verification portion 707 records various information about the abnormality.

[2] Case 2

In case 2, the abnormality processing portion 406 of the parking server 420 and the abnormality verification portion 707 of the OEM server apparatus 700 are assumed to operate as follows. Similar to the first embodiment, the abnormality processing portion 406 determines which communication for another vehicle or the vehicle 320 is hacked. In other words, it is determined whether another vehicle or the vehicle 320 is abnormal. The abnormality processing portion 406 generates the abnormality information Dr containing information around the vehicle 320 at the detection of the abnormality, the chassis frame number and the part number of the vehicle determined to be abnormal, and the time of abnormality occurrence, for example. The abnormality processing portion 406 transmits the generated abnormality information Dr to the OEM server apparatus 700.

The abnormality verification portion 707 receives the abnormality information Dr transmitted from the parking server 420 and diagnoses the vehicle determined to be abnormal. Then, the abnormality verification portion 707 records various information about the abnormality. The diagnosis may include an analysis of the vehicle information. The determination result from the abnormality processing portion 406 may indicate that another vehicle is abnormal. Then, similar to the first embodiment, it may be favorable to retry the automatic operation control based on the parking server 420.

The above-described present embodiment provides the same effect as that of the first embodiment and the following effect. In the AVP system 120 according to the present embodiment, the temporary key, as a digital key for the vehicle 320, is directly exchanged between the OEM server apparatus 700 and the vehicle 320. No temporary key is supplied to the parking server 520. Even if a malicious third party hacks the parking server 520, no temporary key is acquired and there is no risk of deciphering the digital key mechanism of the vehicle 320. The present embodiment provides excellent effects of increasing the confidentiality of the digital key mechanism of the vehicle 320 and increasing the system security.

When generating a temporary key, the OEM server apparatus 700 also generates a password to validate the temporary key. The vehicle 320 receives the temporary key and the password and then provides automatic operation control according to the operation plan. In this case, for example, the authorization to operate the vehicle 320 is given only when both the temporary key and the password are made available. The OEM server apparatus 700 directly transmits the temporary key to the vehicle 320 and separately transmits the password via the parking server 520.

The temporary key and the password are transmitted via different routes. It is possible to reduce the possibility where a malicious third party intercepts both the temporary key and the password by hacking, for example. Even if one of the temporary key and the password is intercepted by hacking, for example, there is no risk of deciphering the digital key mechanism of the vehicle 320, and a third-party hacker will not be given the authorization to operate the vehicle 320. It is possible to prevent the worst-case scenario where the vehicle 320 is guided outside the parking place contrary to the user's intentions and is stolen.

The parking server 520 transmits a set of the generated server-side operation plan Dd and password Dq to the vehicle 320. Suppose the temporary key Da can be successfully unlocked through the use of the password Dq transmitted from the parking server 520. Then, the vehicle 320 can determine that the server-side operation plan Dd received with the password Dq is also true, or is officially transmitted from the parking server 520.

Even if a malicious third party such as a hacker transmits a false operation plan, for example, the vehicle 320 can determine that the correct password is not attached together and therefore the operation plan is false and unusable. There may be the transmission of a questionable operation plan that is generated by a malicious third party and intentionally guides the vehicle 300 outside the parking place. Even in such a case, the vehicle 320 according to the present embodiment does not provide automatic operation control according to such a questionable operation plan and can reliably maintain the system security.

In such a case, the abnormality processing portion 406 of the parking server 420 transmits the abnormality information Dr, indicating the anomaly classification result, to the OEM server apparatus 700. The abnormality verification portion 707 of the OEM server apparatus 700 receives the abnormality information Dr and then verifies the anomaly occurring around the vehicle 320 based on the abnormality information Dr. When an abnormality occurs, the OEM server apparatus 700 can provide solutions unavailable from the parking server 420 alone such as diagnosing an vehicle determined to be abnormal.

The OEM server apparatus 700 stores information about the occurrence of the abnormality. The above-described configuration can provide measures to prevent the occurrence of abnormalities such as examining countermeasures against the causes of abnormalities based on the information stored in the OEM server apparatus 700.

### Third Embodiment

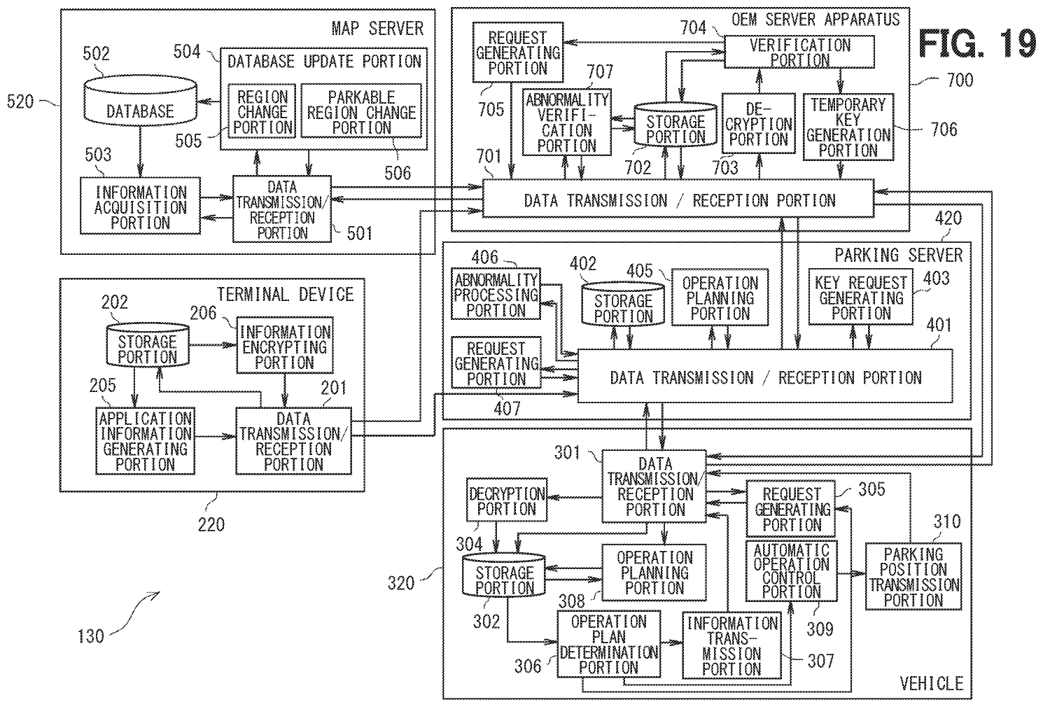

The third embodiment will be described by reference to FIGS. 19 through 22.

As illustrated in FIG. 19, an AVP system 130 according to the present embodiment includes the terminal device 220, the vehicle 320, the parking server 420, the map server 520, and the OEM server apparatus 700, similar to the AVP system 120 according to the second embodiment. However, changes are made to the communication between the vehicle 320 and the map server 520.

Specifically, according to the present embodiment, the vehicle 320 and the map server 520 allow the OEM server apparatus 700 to transmit and receive specific data such as region information request Dg, parkable region information Df, parking position information Di, and starting information Dj. The request generating portion 305 of the vehicle 320 transmits the region information request Dg to the map server 520 via the OEM server apparatus 700. The parking position transmission portion 310 of the vehicle 320 transmits the generated parking position information Di and the starting information Dj to the map server 520 via the OEM server apparatus 700.

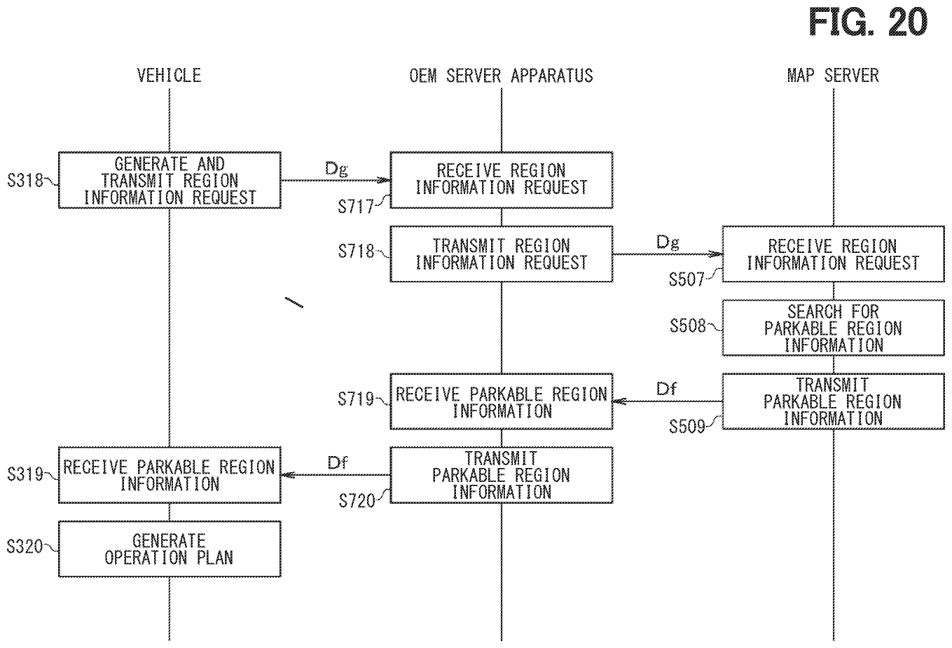

Operations of the above-described configuration will be described. By reference to FIGS. 20 through 22, the description below explains processes performed in the components during the implementation of the AVP differently from the above-described embodiments, specifically concerning the first process of the changeover process, the parking process, and the starting process. The processes illustrated in FIGS. 20 to 22 may include the same step numbers as the first embodiment to represent the same contents.

First Process of the Changeover Process

FIG. 20 illustrates the first process of the present embodiment. At step S318, the vehicle 320 generates a region information request Dg and transmits the generated region information request Dg to the OEM server apparatus 700. The OEM server apparatus 700 receives the region information request Dg at step S717 and transmits the received region information request Dg to the map server 520 at step S718.

The map server 520 receives the region information request Dg at step S507 and searches for various data stored in the database 502 to acquire the parkable region information Df at step S508. At step S509, the map server 520 transmits the parkable region information Df to the OEM server apparatus 700.

The OEM server apparatus 700 receives the parkable region information Df at step S719 and transmits the received parkable region information Df to the vehicle 320 at step S720. The vehicle 320 receives the parkable region information Df at step S319 and then generates a vehicle-side operation plan Dh based on the parkable region information Df at step S320. The vehicle-side operation plan Dh contains a route that guides the vehicle 300 to the target position included in the unmanageable region.

Parking Process

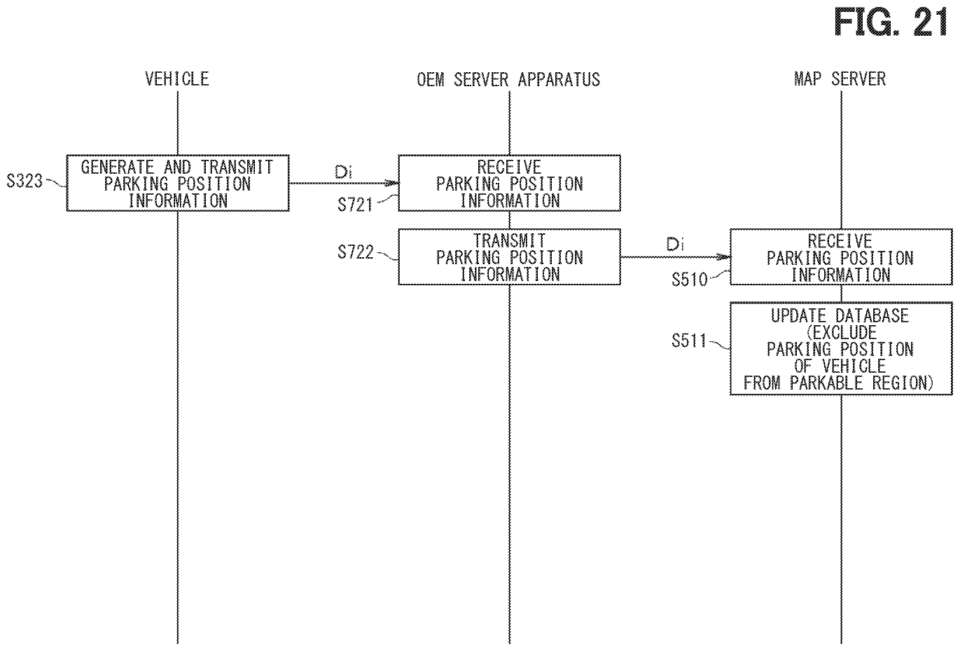

FIG. 21 illustrates the parking process according to the present embodiment. At step S323, the vehicle 320 generates the parking position information Di and transmits the generated parking position information Di to the OEM server apparatus 700.

The OEM server apparatus 700 receives the parking position information Di at step S721 and transmits the received parking position information Di to the map server 520 at step S722. The map server 520 receives the parking position information Di at step S510 and updates the database 502 at step S511 to exclude the region, indicated by the parking position information Di, as a region capable of parking the vehicle 320 from the unmanageable region.

Starting Process

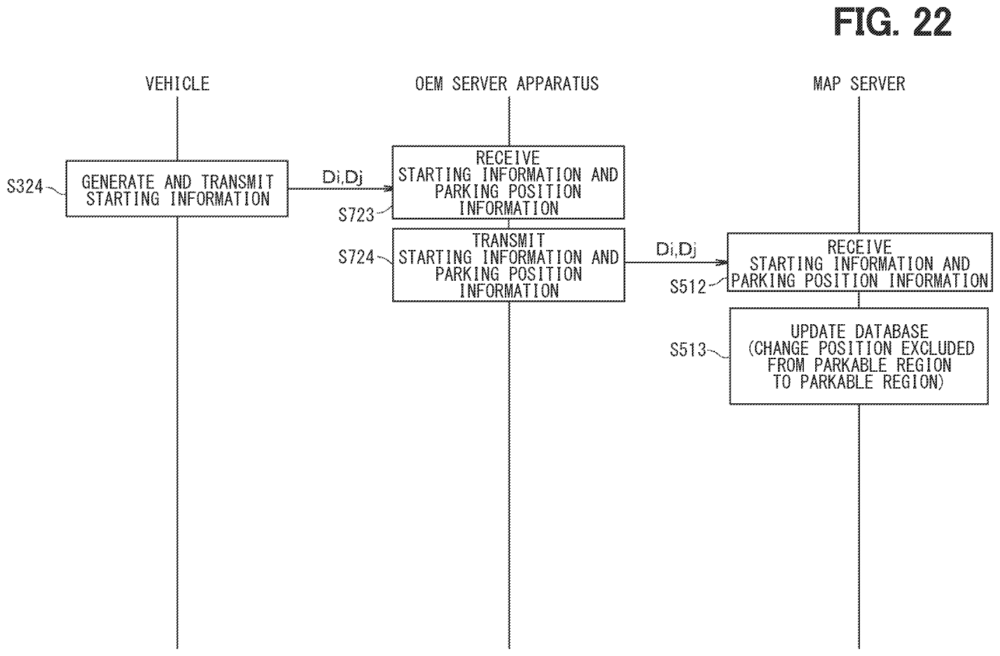

FIG. 22 illustrates the starting process according to the present embodiment. At step S324, the vehicle 320 generates the starting information Dj and transmits the generated starting information Dj along with the parking position information Di to the OEM server apparatus 700.

The OEM server apparatus 700 receives the starting information Dj and the parking position information Di at step S723 and transmits the received starting information Dj and parking position information Di to the map server 520 at step S724. The map server 520 receives the starting information Dj and the parking position information Di at step S512 and updates the database 502 at step S513 to return the region, indicated by the parking position information Di, to a region capable of parking the vehicle 320.

The above-described present embodiment provides advantages similar to the second embodiment. The second embodiment and the third embodiment provide the following merits. The second embodiment enables direct communication between the vehicle 320 and the map server 520 to transmit and receive specific data. Compared to the third embodiment, the second embodiment can simplify the processing related to the transmission and reception of specific data.

The third embodiment enables indirect communication between the vehicle 320 and the map server 520 to transmit and receive specific data via the OEM server apparatus 700. Fundamentally, other data is transmitted and received via the communication between the vehicle 320 and the OEM server apparatus 700 and the communication between the OEM server apparatus 700 and the map server 520. Compared to the second embodiment, the third embodiment can restrain communication paths from increasing.

### Other Embodiments

The present disclosure is not limited to the above-described embodiments illustrated in the accompanying drawings but may be modified, combined, or enhanced variously within the spirit and scope of the disclosure.

Numeric values given in the above-described embodiments are examples and the present disclosure is not limited thereto.

The second embodiment and the third embodiment use the temporary key Da and the password Df for the authentication. However, the authentication may use only the temporary key Da.

The present disclosure has been described with reference to the embodiments but is not limited to the embodiments and structures. The present disclosure covers various modification examples and modifications within a commensurate scope. In addition, the category or the scope of the idea of the present disclosure covers various combinations or forms and moreover the other combinations or forms including only one element or more or less in the former.

The control portion and its technique described in the present disclosure may be embodied by a dedicated computer including a memory and a processor that is programmed to execute one or more functions implemented by a computer program. Moreover, the control portion and its technique described in the present disclosure may be embodied by a dedicated computer including a processor comprised of one or more dedicated hardware logic circuits. Further, the control portion and its technique described in the present disclosure may be embodied by one or more dedicated computers each configured as a combination of a processor programmed to execute one or more functions and a processor comprised of a memory and one or more hardware logic circuits. The computer program as an instruction executed by the computer may be stored in a computer-readable non-transitory tangible storage medium.

1. An automatic valet parking system for providing valet parking under automatic operation control, the system comprising:
a vehicle configured to transmit/receive data to/from other vehicles;
a parking server; and
a map server including a database that stores information relating to regions in a parking place, wherein
the parking place is divided into at least a manageable region that is managed by the parking server and an unmanageable region that is not managed by the parking server,
the parking server includes a server-side operation planning portion that is configured to generate a server-side operation plan including a route for guiding the vehicle to a target position in the manageable region and to transmit the server-side operation plan to the vehicle,
the map server includes an information acquisition portion that is configured to acquire, from the database, parkable region information in response to receiving a request from the vehicle and to transmit the parkable region information to the vehicle, wherein the parkable region information indicates a region in the unmanageable region where the vehicle is able to be parked,
the vehicle includes:
an operation plan determination portion that is configured to determine whether the saver-side operation plan is false;
a request generating portion that is configured to request the map server to transmit the parkable region information when the operation plan determination portion determines that the server-side operation plan is false;
a vehicle-side operation planning portion that is configured to generate, based on the parkable region information, a vehicle-side operation plan including a route for guiding the vehicle to the target position in the unmanageable region in response to receiving the parkable region information; and
an automatic operation control portion that is configured to:
perform the automatic operation control according to the server-side operation plan when the operation plan determination portion determines that the server-side operation plan is not false; and
perform the automatic operation control according to the vehicle-side operation plan when the operation plan determination portion determines that the server-side operation plan is false.

2. The automatic valet parking system according to claim 1, wherein
the parking server includes a request generating portion that is configured to request the map server to expand the manageable region upon determining that no park space exists in the manageable region for the vehicle, and
the map server includes a region change portion that is configured to update the information stored in the database to expand the manageable region in response to receiving a request from the parking server.

3. The automatic valet parking system according to claim 1, wherein
the vehicle further includes a parking position transmission portion that is configured to transmit parking position information indicating a parked position of the vehicle to the map server when parking of the vehicle at the target position in the unmanageable region completes by performing the automatic operation control according to the vehicle-side operation plan by the automatic operation control portion; and
the map server includes a parkable region change portion that is configured to, upon receiving the parking position information, update the information stored in the database to exclude the parked position indicated by the parking position information from the region in the unmanageable region where the vehicle is able to be parked.

4. The automatic valet parking system according to claim 1, wherein
the vehicle further includes an information transmission portion that is configured to acquire vehicle-related information about the vehicle and to transmit the vehicle-related information to the parking server when the operation plan determination portion determines that the server-side operation plan is false, and
the parking server further includes an abnormality processing portion that is configured to, upon receiving the vehicle-related information:
classify, based on the received vehicle-related information and the server-side operation plan, an abnormality that occurred around the vehicle due to the false server-side operation plan; and
perform an abnormality management process according to a classification result.

5. The automatic valet parking system according to claim 4, further comprising:
an OEM server apparatus that is managed directly or indirectly by a manufacturer of the vehicle, wherein
the abnormality processing portion is configured to transmit abnormality information indicating the classification result of the abnormality to the OEM server apparatus, and
the OEM server apparatus includes an abnormality verification portion that is configured to verify an abnormality that occurred around the vehicle based on the abnormality information upon receiving the abnormality information.

6. The automatic valet parking system according to claim 1, wherein
the operation plan determination portion is configured to determine that the server-side operation plan is false when the server-side operation plan includes a route for guiding the vehicle to a location outside of the parking place.

7. The automatic valet parking system according to claim 1, wherein
the operation plan determination portion is configured to determine that the server-side operation plan is false when another vehicle other than the vehicle stops at the target position specified by the server-side operation plan.

8. The automatic valet parking system according to claim 1, wherein
the operation plan determination portion is configured to determine that the server-side operation plan is false when an obstacle interfering with travelling of the vehicle exists on the route including the target position specified by the server-side operation plan.

9. An automatic valet parking system for providing valet parking under automatic operation control, the system comprising:
a vehicle configured to transmit/receive data to/from other vehicles;
a parking server; and
a map server including a database that stores information relating to regions in a parking place, wherein
the parking place is divided into at least a manageable region that is managed by the parking server and an unmanageable region that is not managed by the parking server,
the parking server includes at least one parking server processor programmed to generate a server-side operation plan including a route for guiding the vehicle to a target position in the manageable region and to transmit the server-side operation plan to the vehicle,
the map server includes at least one map server processor programmed to acquire, from the database, parkable region information in response to receiving a request from the vehicle and to transmit the parkable region information to the vehicle, wherein the parkable region information indicates a region in the unmanageable region where the vehicle is able to be parked,
the vehicle includes at least one vehicle processor programmed to:
determine whether the saver-side operation plan is false;
request the map server to transmit the parkable region information upon determining that the server-side operation plan is false;
generate, based on the parkable region information, a vehicle-side operation plan including a route for guiding the vehicle to the target position in the unmanageable region in response to receiving the parkable region information;
perform the automatic operation control according to the server-side operation plan upon determining that the server-side operation plan is not false; and
perform the automatic operation control according to the vehicle-side operation plan upon determining that the server-side operation plan is false.
